(19) United States
(12) Patent Application Publication
(10) Pub. No.: US 2006/0251115 A1
(43) Pub. Date: Nov. 9, 2006

(54) Broadband multi-service, switching, transmission and distribution architecture for low-cost telecommunications networks

(76) Inventors: Samudra E. Haque, Alexandria, VA (US); Abhishek Jain, Alexandria, VA (US)

Correspondence Address: BLANK ROME LLP, 600 NEW HAMPSHIRE AVENUE, N.W., WASHINGTON, DC, 20037, US

(21) Appl. No.: 11/293,120

(22) Filed: Dec. 5, 2005

Related U.S. Application Data
(60) Provisional application No. 60/633,195, filed on Dec. 3, 2004.

(51) Int. Cl. H04J 3/16

(52) U.S. Cl. 370/466

(57) ABSTRACT

A low-cost, distributed broadband multi-service communication network includes intelligent hybrid communication nodes which communicate with one another. The hybrid communication nodes have multi-media interfaces and processors that allow the node to receive a communication broadcast at one protocol interface, convert the broadcast to other communication protocols, and route it to those different communication protocol interfaces for transmission to other communication media. The smart hybrid communication nodes provides a distributed system that does not rely on a central intelligence, so that the network can be instantly deployed and expanded. In addition, a weatherproof container permits the nodes to be physically mounted adjacent to a communication antenna. This eliminates the need for a cable to connect a transmitter interface to the antenna (which can be several hundred feet away at the top of a tower). Even expensive cable results in substantial power and signal loss.

### RELATED APPLICATION

This application claims priority to provisional application Ser. No. 60/633,195, filed Dec. 3, 2004, which is hereby incorporated by reference.

### BACKGROUND OF THE INVENTION

1. Field of the Invention

The present invention relates to low-cost, broadband multi-service communications networks. More particularly, the present invention relates to such networks in which switching, transmission, and distribution functions are accomplished by intelligent hybrid network nodes built out of common computer and electronic components.

2. Background of the Related Art

Telecommunications network design architectures in use in the global marketplace are centralized. Examples of centralized networks include: Public Switched Telephone Networks, Mobile Telephone Switching and Transmission Networks, Wireless Local Loop Networks, Wi-Fi standards compliant network architecture, WiMax standards compliant network architecture, Broadband wireless networks mobile, referring to IEEE 802.20 proposed standards family, Broadband cable networks used commonly to deliver Cable Television, Internet and Telephony applications, Mesh Networking (Wireless LAN Mesh networks and nodes), and Others.

In each of these networks, services can only be effectively delivered in specific target areas that have dense population demographics. The systems do not make it easy to spread communication services to sparsely populated, rural areas where heavily centralized services cannot be rolled out without investment in civilian and electrical/electronic infrastructure first. The traditional approach in these older methods is to have a certain class of devices responsible for “transmission” and another class of devices responsible for a combination of “switching and/or routing and/or distribution”.

The telecommunications technology is not able to adequately satisfy the needs of the “low-income” populations typically found in rural or urban areas or infrastructure-poor areas. Wired network customers either have twisted copper pairs or coaxial cable connections delivered directly to their home or office building as a circuit and Wireless/Radio network customers/users would have a radio equipped customer premise equipment along with suitable antenna either directly attached to their computer or to their Local Area Network. Each equipment of the network operator requires a separate power supply and if they would be in service continuously, a bank of fans to dissipate the heat from within the equipment and air conditioning units to provide a managed environment in the enclosure.

A principle drawback of the centralized setup is that it is expensive and cumbersome, and expansion capability is limited to the amount of available service connections present in the equipment used in service. In addition, service coverage in wired networks are dependant upon the type of cabling used to deliver the services to homes/businesses and its physical transmission characteristics. Typically for twisted pair copper circuits that would carry voice or low-speed data traffic, customers could be located up to 30,000 feet away from the location of this centralized setup (a.k.a. central office). For high-speed broadband services such as DSL, the distances would be limited to approximately 20,000 feet or closer and be heavily dependent upon the actual quality and physical properties of the copper wire being used and the link would be susceptible to any variation in humidity or temperature.

Customers having their own physical copper pair circuits are fortunate to have a dedicated communications path back to the Central Office, but only because there are huge numbers of individual copper pairs bundled together in primary, secondary and tertiary trunk cables which form the basis for an Outside Cable Plant and which are laid all the way back to a Central Office, or a local telecommunications multiplexer which is connected to the Central Office via a fiber optic cable.

For coaxial cable connections, or mixed environments where fiber optic cables and copper coaxial cables are used simultaneously, each house/business is provided with essentially a shared connection that has two different connection speeds for data going from the Central Office to the subscriber and for data going back to the Central Office from the subscriber which is generally lower due to limitations in allocated bandwidth on the coaxial repeaters in the upstream (customer to CO direction).

Management of such large numbers of external cable facilities represents a large capital expenditure for deployment. Substantial operating expenses are also incurred for regular maintenance. In addition, the physical distance limitations of wired networks are why broadband services cannot be delivered to communities which are located at the periphery any selected Central Office. If additional Central Offices have to be constructed to extend services to outlying communities, then entire new infrastructure to support small/medium Central Offices have to be set up and the new Central Offices have to be connected back to the core networks with backhaul facilities which often consist of fiber optic or high capacity microwave communication links.

For a small collection of users in a telecommunication network, Time Division Multiplexing of circuits works well for switching of voice and data. However, for large numbers of broadband data and voice services, it is common to find very large scale telecommunications switches employing packet switched standards such as Frame Relay, ATM, IP or MPLS (Mixed IP/ATM) to convey more traffic over point to point networks which span the system of points-of-presence in a local region.

Early industry solutions used fixed frequency carriers (known as frequency division duplexing) to deliver individual channels of two-way voice/data communication over certain geographic area in a circular pattern (or specialized patterns to match the geographic terrain) from a tall communications tower through a power transmitter/receiver directly to customer premise equipment that would be set to particular frequencies while in operation. Due to the scarcity of frequency spectrum, this early approach has been replaced with more efficient methods of spectrum allocation, found mostly in wireless local loop telephone systems (WLL, TDD) where channels are shared between the numerous radio stations in a network and controlled by a network switch which can be programmed to respond in various ways to the demands of subscribers, depending upon where they are and what they want to do.

Essentially a top-level radio/fiber network of Central Office switches has to be set up before each area covered by Central Office based radio network switches can be employed to provide on-demand telecommunications service to subscriber radio stations. Thus, the capacity to expand is dependent directly upon the physical trunking/switching capability present in each BTS and BSC, which are usually placed close to the communities they serve. Network expansion is also limited by the cost-economics of the BTS, BSC and MSC and the physical geography of the area that the service is intended to cover.

For subscriber stations that have only limited or no mobility requirements, Fixed Broadband Wireless Access (FBWA) networks are available from various vendors, such as Nortel and Motorola. Each offer attempts to solve the issue of delivering a lot of bandwidth from the central point of presence to the subscriber location, and a relatively thin return service to accommodate network service requests. The general architecture is that of several large cells formed by an antenna constellation in an omni-directional radial pattern, and up to two additional levels of infrastructure, repeater stations and subscriber stations.

The subscriber stations have to obtain service from either a nearby repeater station or a base station, and they cannot be converted into either repeater station or a base station. As the FBWA network signal is transmitted across an entire region from a set of transceivers at the base station, service coverage gaps are inevitable, which need to be filled up by deploying additional repeater stations connected to the base stations by backhaul links. The principal difference between FBWA and mobile networks is that the customer premise equipment of a FBWA supports full LAN and voice service features which can act as a proper network gateway. A mobile network equipment/terminal, such as a cell phone, is predominantly a voice device with optional limited data services capability.

Both FBWA and Mobile Networks have their advantages in providing a quick solution to connect subscribers in most areas, but they also have significant drawbacks. For instance, most of the switching and transmission equipment used to provide FBWA and Mobile Network services are physically large enough that the equipment is usually housed in a environment controlled radio room either on the ground floor or a rooftop cabin or placed in a portable hut. Several very large diameter coaxial cable of heavy construction is used to connect the output of the radio transceivers with antennas, which are placed atop elevated locations or a purpose-built communication tower. All this infrastructure requires significant capital expenditure to procure, and operating expenses to maintain.

In addition, FBWA and Mobile Networks have the disadvantage that radio transmission equipment in use has to be able to deliver enough RF output power to the farthest subscriber who is within the “cellular” area of the network point-of-presence. More importantly, the reception equipment has to be able to pick up the subscribers signal from very far away. This puts a limitation on the amount of transmit power that can be generated from a communications tower before distant and weaker stations would be unable to access the network as it would never notice the faint signals.

In addition, the loss associated with the physical transmission characteristics of the coaxial cable in use from the antenna to the radio further limits the total power that can be safely delivered across the “cell” and likewise limits the strength of the signals being received at the point-of-presence from the farthest part of the assigned “cell”. This same issue affects the use of radio amplifiers installed at the antenna feed point as the attached equipment becomes so sensitive that any nearby transmission that cannot be blocked or attenuated electro-mechanically will affect the link adversely with potential catastrophic results.

In addition, FBWA and Mobile Networks have the disadvantage that if a base station were to be unable to maintain routine operations due to any technical fault, then all subscribers in that “cell” would be disconnected from the network, unless another “cell” base station would be available with overlapping coverage—and if the subscriber device was authorized to connect to that network. Potential for single point of failure in a network is significant.

In addition, FBWA and Mobile Networks have the disadvantage that in order to reduce signal loss on the transmit path for extended range, and to accommodate efficient reception practices, many network operators deploy aluminum tubular waveguide and sectoral antennas from the radio room to the communications tower and extend the same tubular waveguide directly to the feed point of the antenna. This waveguide concept is useful but expensive and quite difficult to maintain over such a long distance.

In addition, FBWA and Mobile Networks have the disadvantage that if extra base stations or extra repeaters are required, then capital expenditures increase and recurring expenses increase even higher as additional monthly charges are incurred for rooftop license rights and cost for right-of-way easements across private property for the necessary backhauls.

In addition, FBWA and Mobile Networks have the disadvantage that separate classes of transmission and switching equipment are required to build FBWA and Mobile Networks, and the equipment is not adaptable between the two categories. The customer premise equipment and handheld devices are not designed to be useable as either transmission or switching equipment.

Compared to the existing FBWA and Mobile Networks, radio data networks utilizing the properties of newly re-introduced spread spectrum modulation techniques such IEEE 802.11b/g/a and IEEE 802.16 and similar communication networks are being setup to serve many thousands of subscribers simultaneously while operating intentionally in a limited portion of the radio spectrum. Based upon the notion that a single modulated carrier containing data over a given spectrum can be artificially spread throughout a larger slice of radio spectrum of at least 10 times the original carrier size, it is possible to reduce the power level of the spread carrier to such a small degree that it would be almost indistinguishable from background noise.

However all sender and receiver stations in a network have to be synchronized to each other with the same spreading technique and utilize the same set of RF carriers for network traffic to be carried efficiently. In the IEEE 802.11 family of standards, either Direct Sequence Spread Spectrum or Orthogonal Frequency Division Multiplexing method of modulation is selectively utilized to ensure that in a congested environment, each radio subscriber station that wants to access the network can do so if their transmission power is of such a magnitude that it can reach the base station.

Radio networks in the IEEE 802.11 family can be either of point-to-point (Sender and receiver form a pair of links) and point-to-multipoint which is commonly referred to an access point or AP. The key deficiency of the IEEE 802.11 family of standards is the relative lack of robust quality of service measurement, monitoring and mitigation facilities, which has prevented its adoption as a core transmission and networking protocol for telecommunications. IEEE 802.16 Wi-Max standard implementations with an enlarged set of OFDM carriers and extensive quality of service and network management features attempts to overcome these obstacles.

But, due in part to its reliance on a the old “cellular” base station network architecture, it continues to suffer, albeit differently, from the same issues of blockage, power limits, expansion capability and single point of failure. While the quality of service benefit along with the increased number of orthogonal RF channels implies large traffic handling capacity, Wi-Max or its other similar standard Wi-Bro are essentially a large scale Wireless Access Point and are limited to small geographic area coverage. There is no possibility of expansion at the base station, except for addition of a separate backhaul link to another location where there will be another Wi-Max or Wi-Bro base station setup and the cycle will be repeated.

### SUMMARY OF THE INVENTION

A low-cost, distributed broadband multi-service communication network is provided which includes intelligent hybrid communication nodes which communicate with one another. The hybrid communication nodes have multi-media interfaces and processors that allow the node to receive a communication broadcast at one protocol interface, convert the broadcast to other communication protocols, and route it to those different communication protocol interfaces for transmission to other communication media. The smart hybrid communication nodes provides a distributed system that does not rely on a central intelligence, so that the network can be instantly deployed and expanded. In addition, a weatherproof container permits the nodes to be physically mounted adjacent to a communication antenna. This eliminates the need for a cable to connect a transmitter interface to the antenna (which can be several hundred feet away at the top of a tower). Even expensive cable results in substantial power and signal loss.

The present invention includes system architecture for building large scale, high capacity, telecommunication networks using low-cost intelligent hybrid network nodes built out of common computer parts and electronic components, modules and mechanical parts from various industrial sources. The nodes are placed into a service network connected to various physical media and organized as a partial-mesh of hybrid network nodes. Persons having basic computer knowledge are able to manufacture these low-cost hybrid network devices out of basic computer parts, and gain the ability to repair the systems in the field by utilizing spare parts of other computers and technical equipment if needed.

Accordingly, this invention is not dependent upon any particular communications industry standard technology and the principles behind the invention can be uniquely used to build out telecom services necessary in order to implement a “Zero-Infrastructure” solution where equipment built according to the invention guidelines can be operated on a stand-alone basis to form a primary level service network. The system is modular and re-useable in concept allowing re-use of technology components (present, and future) where necessary in order to have a simple growth path where users start to service small geographic areas through small scale hybrid nodes. Then, if desired, they can easily extend the service to large areas or very long distances by simply interchanging a small number of components, which is a distinct advantage compared to existing and proposed other commercial communications solutions and by interchanging components to have the very same hardware platform take on the function of Router, Switch, Transceiver, Multiplexer, Terminal, Modem or a combination of the listed functions.

These and other objects of the invention, as well as many of the intended advantages thereof, will become more readily apparent when reference is made to the following description, taken in conjunction with the accompanying drawings.

### BRIEF DESCRIPTION OF THE FIGURES

FIG. 1 is a block diagram of a Broadband Router in accordance with a preferred embodiment of the invention;

FIG. 2 is a block diagram of a Broadband Wireless Router;

FIG. 3 is a block diagram of a Hybrid Communications Node;

FIG. 4 is a block diagram of a Hybrid Communication Node specially designed for telephony application;

FIG. 5 is a perspective drawing of the antenna mount;

FIG. 6 shows the Broadband Wireless Router connected to a BMSTDA service area and antennas;

FIG. 7 shows an MMRU implemented with antennas and the BMSTDA;

FIG. 8 is a block diagram of the MMRUs of FIG. 7;

FIG. 9 is a schematic of the BMSTDA in accordance with the invention;

FIG. 10 shows the data rate and distance of the invention;

FIG. 11 shows the network topology of the invention;

FIG. 12 is an illustrative example of the BMSTDA;

FIG. 13 shows telephony interfaces in a Hybrid Communications Node and a flow chart of a single line telephone interface management process;

FIG. 14 is an illustrative example of the Hybrid Communication Node;

FIG. 15 is another illustrative example of the Hybrid Communications Node;

FIG. 16 is a block diagram of two-part bi-directional RF amplifier with DC power injector;

FIG. 17 is a flow chart showing operation of the fault management process;

FIG. 18 is a front plan view of the MMRU outdoor unit in accordance with another embodiment of the invention;

FIG. 19 is a front plan view of the unit of FIG. 17, with the cover removed;

FIG. 20 is a cut-away side view of the unit of FIG. 17; and,

FIG. 21 is an exploded view of the unit showing the seal created between the cover and outer shell.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents that operate in similar manner to accomplish a similar purpose.

Hybrid Communication Node—Architecture Details

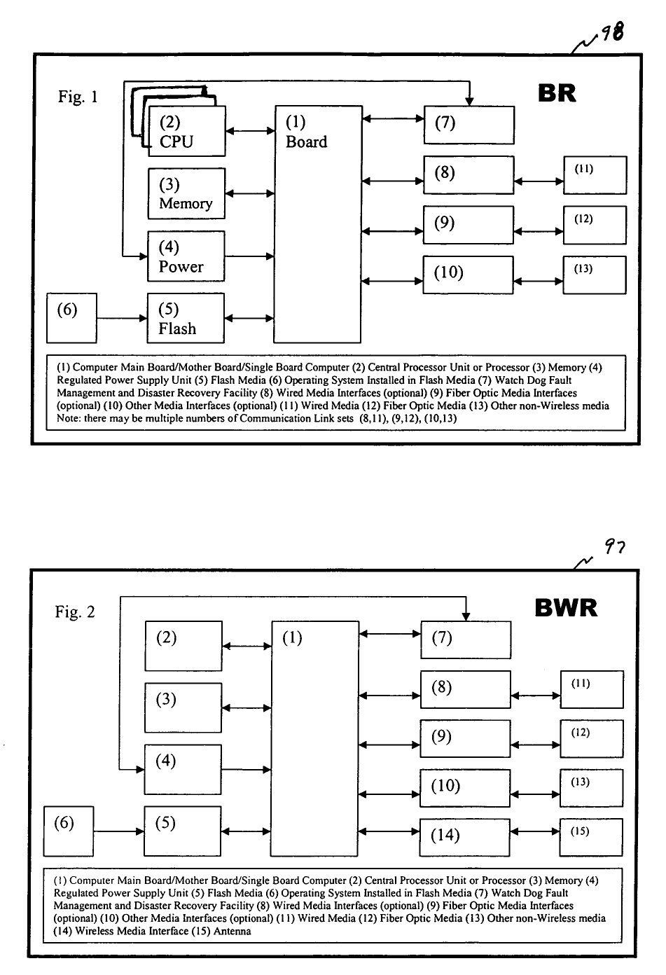

Turning to the drawings, FIGS. 1-3 show various configurations for a hybrid communication node 99 in accordance with the present invention. The hybrid communication node 99 can include a main board 1, a processor 2 (optionally with a primary, secondary, tertiary and/or backup processors), memory 3, regulated power supply 4, flash media 5, operating system 6 (which is implemented by the processor 2), watch dog fault management and disaster recovery 7, wired media interface 8, fiber optic media interface 9, other media interface 10, wired media 11, fiber media 12, non-wireless media 13, wireless interface 14, and antenna 15. The hybrid communications node 99 is not limited to the elements shown, but rather can include any suitable elements or inter-connections that will be needed to be established to operate the system as a whole in a reliable manner for any particular application.

FIG. 1 depicts a Broadband Router (BR) configuration 98, whereby the node 99 is configured as a basic router having a few elements of the more comprehensive system diagram of FIG. 3. Here, Radio Interfaces are denoted also as element 47. The BR 98 has wired interfaces 8 which establish a multi-homed network device. The Flash Media 5 of FIG. 1 is represented in FIG. 3 as the Storage Device 5. The Monitoring and Control Communications Service Facility 56 of FIG. 3 is absent from this particular embodiment to illustrate that a simple configuration with no extra peripherals meets the basic requirements of a Hybrid Communication Node 99. The Monitoring facility 56 is included where redundant performance is needed.

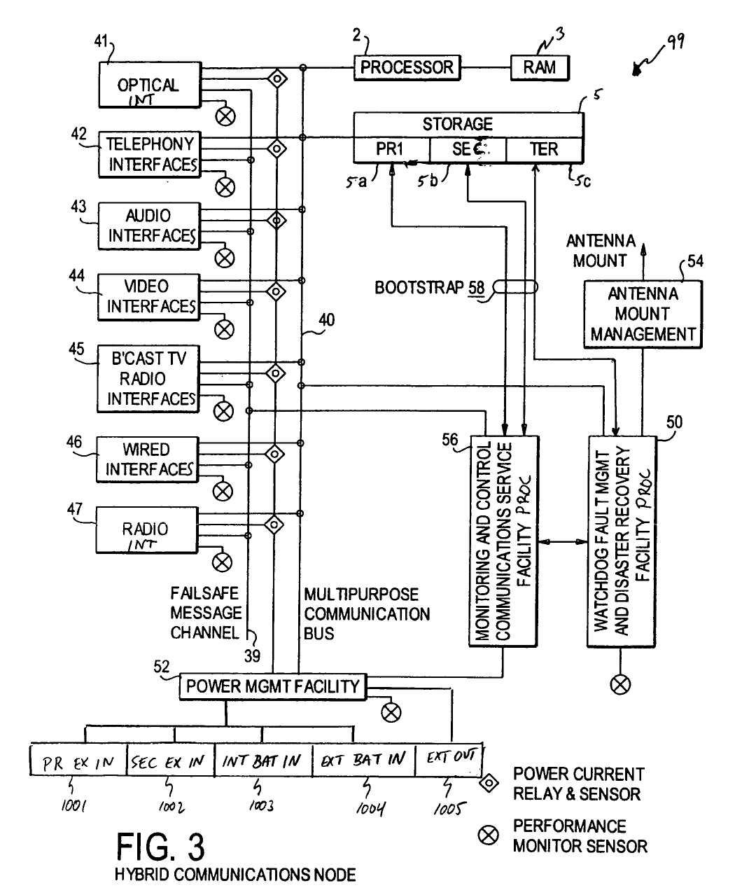

Turning to FIG. 2, the basic router application of FIG. 1 is enhanced with the addition of radio interfaces 47 which convert the Broadband Router 98 into a Broadband Wireless Router (BWR) 97. With reference to FIG. 7, the BWR 97 can be installed within an enclosed premise to take on the functions of a conventional telecommunications central office and connect to the wired network (denoted in FIG. 7 as the BMSTDA Service Area 23). The BWR 97 can also connect to remote Hybrid Communications Nodes 99 through either dedicated point-to-point or shared point-to-multipoint radio links, as an example of the radio interface 14.

As best shown in FIG. 3, the hybrid communications node is preferably a general purpose computer having a System Board 1 with a multi-purpose communication bus 40, Central Processor 2 and associated peripheral components necessary for low-level system monitoring and control such as Performance Monitor Sensors, and Power Relay and Current Sensors. Performance Monitor Sensors are pre-programmed sensor sub-assemblies that are connected directly to the components or assemblies that need monitoring, and each sensor is designed differently according to what device(s) it needs to monitor.

The Power Relay and Current Sensor is a miniature electronics hardware module which operates as an electronic switch to power on/off the connected device. There is preferably at least one Power Relay and Current Sensor per individual module and large component sub-assembly in Hybrid Communication Nodes. The switch is remotely controlled by the Power Management Facility. When the switch is off, no current flows and the attached device is disabled. When the switch is remotely turned on, current flows into the attached device, and a calibrated current sensor which is in series with the load device measures the current utilization of the attached module or large component sub-assembly, digitizes the data and sends it back to the Power Management Facility for eventual monitoring.

By utilizing this monitoring facility in a circular fashion (power is delivered, current is monitored, telemetry is sent back), the Power Management Facility 52 can determine if the attached device that has turned on is working within nominal capacity as it will have been programmed during construction as to what the typical variation in current consumption and average of current consumption will be. In case an attached device is not functioning, or is functioning with degraded performance, the current flow will be either zero, much less than nominal or much more than nominal. However if the current flow is within nominal +/−5% to +−/−7% then that may be considered to be acceptable and the module operation permitted.

The output of any particular Performance Monitor Sensor is in the form of continuous telemetry data for the monitored device which will be sent for interpretation to the Watch Dog Fault Management and Disaster Recovery Facility 50. Random-access read-write memory 3 is used as a temporary location to store program code and data while the processor is active. Multiple banks of Random Access Memory 3 can be utilized to provide a safety feature for continuous systems operations where failures in one portion of the installed Random Access Memory banks can be mitigated by disabling the affected portion and re-allocating the remainder memory in a reduced configuration.

If multiple processors 2 are available in any node 99, one of the processors 2 is dedicated to provide Primary Functions and the others will be dedicated to provide Secondary Functions of the Operating System Environment The Primary functions are executed when the node 99 is working with the system in good health as determined by the Watch Dog Fault Management and Disaster Recovery Facility. When a fault of any kind (due to either Hardware, Software, Network Interface, Network Traffic or other) happens and is monitored, depending upon the severity of the problem, the node 99 is expected to switch to a fail-safe mode of operation purposefully designed to provide reduced functionality across various possible catastrophic conditions.

If there had been only one instance of an Operating System, installed and being executed for only one processor, then any major fault would effectively be a reason for system shutdown or hard reset and reboot. By adopting a pro-active approach to design in a backup/fail-safe mode of operation defined by the system functions as Secondary, we can ensure the node 99 will continue to be operational in far graver and hostile conditions than most other communications devices when failure occurs. Any suitable version and form of the processor 2 can be used to implement these objectives, such as common central processor units, application specific digital signal processing sub-systems and embedded micro-controllers.

The non-volatile erasable and rewriteable memory 5 is connected to the board 1 to provide storage space for the operating system. The memory 5 is preferably partitioned into a primary storage 5a, secondary storage 5b, and additional storage 5c, in order to accommodate the needs of upgrading the operating system while the node 99 is actually in operation. The board 1 has read/write access to memory 5, while at the same time, an additional method for read/write will be available from any of the network interfaces using a special facility called Bootstrap Facility 58 which allows direct loading of Operating System Environment software modules into the Non-Volatile erasable and rewriteable memory, without any primary or secondary processor being started up or needing to be available.

The node 99 preferably comprises most of the elements of a standard computer, and can even be an older computer which might otherwise be discarded. Almost any computer can be used to implement the invention, and it need not have a full operating system, but can be programmed with a BIOS (basic input/output system) to provide functionality for a particular application only. The computer also need not have a hard drive, keyboard, video monitor, video adapter, flash memory or serial and parallel printer ports. All that is needed is to tie the interfaces together in a routing application and optionally in a switching application if desired, in accordance with the invention.

Interfaces—General Overview

The node 99 connects with various media by providing an appropriate interface so that cross-related functions are provided. For instance, in the examples given below, the node 99 can integrate telephony, video, and/or audio content. It should be noted, however, that the examples set forth are illustrative of the invention. Any interface and media can be implemented in the system without limitation to those described here.

The interfaces 8-10 and 14 indicated in FIGS. 1-2 are preferably modular electronic adapters that connect the physical media 11-13, 15, respectively, to the multi-purpose communication bus 40 of the Hybrid Communication Node 99 to allow either one-way or two-way transmission. Each interface 8-10, 14 can be used independently as needed in the overall system.

The transmission/reception capacity of each interface is dependent upon the following combination of factors: the type of media to which the interface 8-10, 14 is attached to, the power available for transmission to another Hybrid Communication Node 99 connected at a distance to the same media, the available amplification factor on the receiver to receive similar transmission from a far away Hybrid Communication Node 99, the noise figures in the assigned spectrum band and the allocated bandwidth within that spectrum band, potential interference with other transmitters (if any) in the same allocated spectrum or assigned spectrum band or adjacent channels/circuits, fading due to environmental factors (if applicable) and the modulation technique employed to convey information within the electrical/optical/radio parameters of the interface. By understanding the relative importance of the preceding mitigating factors, reliable performance models can be calculated in advance that can be used to plan and layout a network of Hybrid Communication Nodes 99 over any geographic area in advance.

Depending upon the type of interface 8-10, 14 that is used, a suitable transducer or an emitter may also be employed to convey an electromagnetic, optical, audio or video signal to the medium used. For example, for Radio transmission/reception, an antenna is necessary to access the medium (i.e., air). For optical transmission/reception that can be conducted using visible light, air is again used as a medium through which an emitter/receptor is directly put into contact with air in order to send the signal across a certain distance where it will be received at a similar interface on another device.

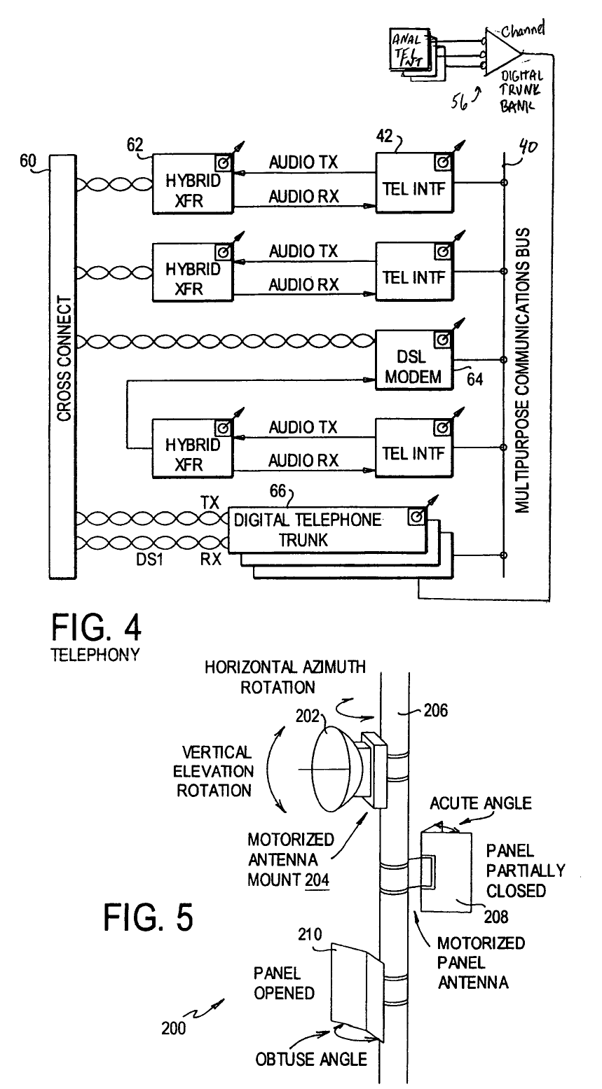

As further shown in FIGS. 1-2, a variety of communication and network interfaces 8-10, 14 are connected to the board 1. In the expanded and detailed diagram of a Hybrid Communication Node in FIG. 3, it can be seen that elements 42, 43, 44, 46 all are classified as Wired Media and hence connected through Cross Connect 60 (FIG. 4); element 41 is classified as Optical Interface(s) which could be either Free Space Optical transceivers 417 or Fiber Optic cable transceivers 416. The processor 2 interprets and utilizes the data communications emanating from the interfaces 8-10, 14 and relays the traffic to other interfaces after appropriate conversion.

As an example of this conversion and relay of traffic, turning to FIG. 14, a versatile streaming media server is shown to broadcast high quality video and audio (multi-media) content over a diverse network. The Hybrid Communication Node has Video, Audio, Fiber Optic Cable and Free Space Optical Transceiver interfaces. The media server sends the multi-media data stream through a Local Area Network Interface 469 which receives the packet stream and delivers it to the processor 2, via the Multipurpose Communications Bus 40, which then routes or switches the packet stream to external networks via a Fiber Optic Cable Interface 416 and simultaneously transmits over the air to another nearby node 99, through a Free Space Optical Transceiver Interface 417. For the purposes of local display of the multimedia content, a simultaneous copy of the data stream is routed through the Multipurpose Communications Bus 40 to a Video Interface 44 and an Audio Interface 43 for delivery to a A/V Monitor, which could also have been broadcast if a TV or Radio modulator were employed.

Furthermore, for access to media such as coaxial cables twisted or untwisted copper cable, a suitable transceiver can be used to convert the electrical signal to a Radio Frequency signal which is then transmitted coupled to the media with a transducer. For Audio and Video and Data signal interfaces, a non-RF baseband signal of sufficient bandwidth is generated/and then connected directly to copper cabling which sends the signal to the intended recipients. In the reverse direction, if a transmitter sends Audio/Video/Data signals, the receiver accepts and attempts to handle that signal according to the type of transmission. If the intended audience for Audio and Video signals is within the local area where the Hybrid Communication Node 99 is deployed, instead of connecting to another node, a speaker or television monitor can be used as a delivery platform.

This method allows very innovative telecommunications call boxes or iiosks to be setup rapidly and in locations where there are no existing telecommunications networks present. The Hybrid Communication Node would have the internal resources to provide for all the required communication service infrastructure and would also have the ability to connect across very long distances (>60 Km in a single direction) to establish two-way connectivity to the public switched telephone network. Alternatively, if a reliable right-of-way is available for laying fiber optic cable, then a fiber optic emitter/transducer/transceiver can be used to connect the interface to fiber optic coaxial media.

Telephony Interfaces

The node 99 can be used for telephony applications by providing one or more telephony interfaces 42. In the field of telecommunication services, the Public Switched Telephone Networks require that subscribers use a registered telecommunications terminal (e.g., telephone set, mobile telephone set) to access a telecommunications switched network (fixed, mobile) which is connected to the portfolio of services (e.g. dial tone, subscriber trunk dialing,) provided by a telecommunication switch. Prior to the Hybrid Communication Node 99, these functions would require a large number of individual equipment from a variety of manufacturers to be connected into a heterogeneous service infrastructure, and using a node 99, all of the required services are available on an immediate basis. This feature is not traditionally found in low-end communications hardware as due to the CPU bandwidth requirements of processing voice channels at 8000 audio samples/second at 8 bits/sample or 64 kbps per voice channel, and additional processing power for transcoding the audio streams to different IP formats if Voice Over IP implementation is required.

The functionality of a telecommunication switch present in such a small package would obviate the need for a large central office, saving capital expenses and operating expenses if a centralized telephone network were to be replaced with distributed networks using Hybrid Communication Nodes serving telephony applications. For instance, two-way analog speech signals, as further shown in FIG. 4 can be exchanged between either a Hybrid Communication Node 99 and a telephone set/telephone exchange, or between two Hybrid Communication Nodes 99.

In these cases, an audio hybrid transformer 62 is provided to multiplex the transmit and receive audio on the same electrical interface circuit if the there are only two parties involved. This is a useful feature when two remote locations need to establish point to point connections without the presence of any existing telecommunications network (or when a existing fixed telecommunications network is not working due to perhaps natural disasters), along with full broadband communications capability as described elsewhere through Primary and Secondary Functions.

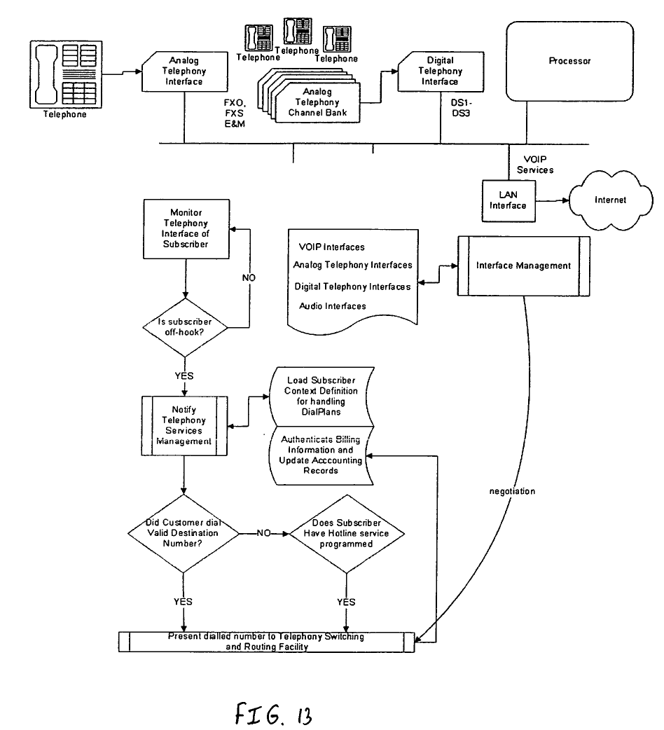

To service up to 12 simultaneous parties using wired telephony applications, a bank of 12 analog telephone interfaces 42 are provided, as generally shown in FIG. 13. In addition, a private automated branch exchange software application provides analog FXO (Foreign Exchange Office), FXS (Foreign Exchange Subscriber), E&M (Ear and Mouth), signaling methods to manage the demands of the subscribers who would like to connect with each other through dialing to each other, and through other network connections external telecommunications network worldwide.

If a high degree of efficiency and scalability in telephone usage is desired, then several digital trunk telephone interfaces 66 (FIG. 4) may be installed in the Hybrid Communication Node 99 which provide time-division multiplexed trunk circuits suitable for connecting to the Public Switched Telephone Network, carrying either 24, 48, 72, 96, 384 or 30, 60, 90, 120, 480 channels. And, signaling methods such as FXO, FXS, ISDN PRI (Integrated Services Digital Network, Primary Rate) can be utilized to communicate with the remote nodes 99.

The features and benefits of the local telephony service can be further enhanced with additional support from a complete software telephony switch application which is and integrated part of the Operating System Environment. That is, the node 99 Telephony Services Management software module manages not only the telephone interfaces (analog, digital, cellular (GSM, CDMA, etc.) but also the switching of analog calls between similar analog telephony interfaces and routing of digital calls that have been encapsulated as VOIP packets. It does this through by providing dial tone across a variety of interfaces, converting the voice signals from the digital telephony trunk 66 or analog telephony interfaces 42 and processing the signals through the multi-purpose communications bus 40 in real-time.

Audio Interfaces

The Hybrid Communication Node 99 also handles audio transmission over baseband interfaces by providing one or more audio interfaces 43. It is uncommon in the industry find audio interface on any system intentionally designed as a flexible router and switch, and the application for these audio interfaces could be as simple as advertising or complex such as automated messages. Here, the Hybrid Communication Node 99 sends single channel audio over a single interface, and stereo or multi-channel audio over multiple physical interfaces 43.

The audio interfaces are bi-directional, they can receive and transmit, simultaneously. The outgoing audio can also be modulated to contain low-speed digital data using modulation techniques such as Frequency Shift Keying (FSK) if so required, or to decode FSK audio signals from an incoming transmission. This non-standard method of modulation may be necessary to convey telemetry and system monitoring data over conventional audio channels in the absence of any public switched telephone network.

Video Interfaces

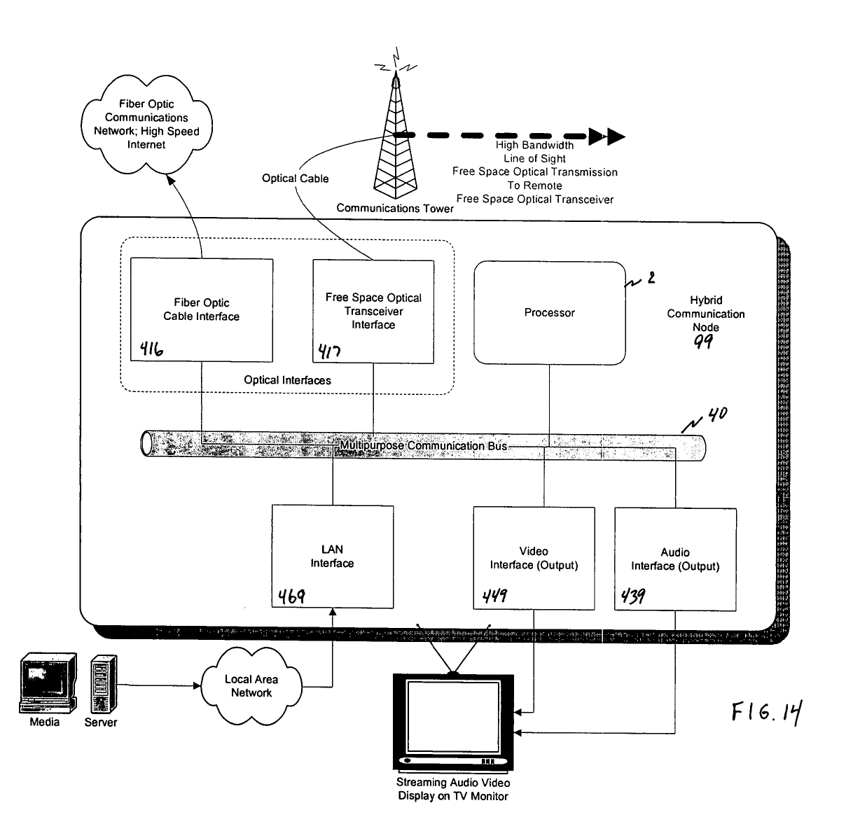

The node 99 can also handle video transmission by employing one or more video interfaces 44 to handle several types of video sources such as a camera or satellite receiver, video tape recorder, or video CD player. To send and receive video transmission over baseband interfaces, each video stream has one physical interface dedicated to either sending or receiving data. With reference to FIG. 15, a video interface operating as a receiver 447 (Digital), 448 (Analog) is able to be physically switched (via video switcher 400) to a suitable encoder 450 so that the content being received from external sources is processed through the multi-purpose communication bus 40 and then encapsulated as IP packets. The content is then sent out from the Hybrid Communications Node as routable packets of streaming video content 460 to the required destinations.

Broadcast TV/Radio Interfaces

The node 99 is also able to handle broadcast TV and radio by providing one or more broadcast interfaces 45. Since the Hybrid Communication Node 99 is typically located in close proximity to habitation, it makes an excellent platform to deliver TV and radio transmission for a small area (<10 kilometers in diameter circle from the location of the node 99, with only low-power output through a high-gain broadcasting antenna, or directly through an interconnection to the Cable head-end of a Cable TV transmission network. In both cases, the TV and Radio service can be delivered efficiently, at extremely low cost to areas that may not get good reception from a centralized TV station transmitter far away, or who want to operate small broadcast stations.

For on-air broadcast of Video transmission, a Video RF Modulator interface can be employed to generate VHF or UHF signals suitable for reception by television sets and for onwards transmission through cable television networks. A Video Modulator could also accept audio directly from a local audio interface, or from a remote streaming audio source, and use either PAL or NTSC Broadcasting modulation standards to create a broadcast signal with a Video carrier and Audio sub-carrier. Similar methods can be extended to stereo TV transmission and digital HDTV transmission by employing different versions of a Video Modulator when required, or by employing a versatile modulator that supports multiple standards.

If on-air monitoring of existing Broadcast transmissions within the neighborhood that the Hybrid Communication Node is operating within, are desired, either of a Broadcast TV Demodulator 458 or Broadcast Radio Demodulator 456 interface can be employed which works in tandem with an incoming audio interface 43 to convert the AM or FM transmissions to streaming digital audio packets suitable for onwards broadcast through the multi-purpose communications bus and any network interface, again with reference to FIG. 15.

An inbuilt mixer and switcher 400 will be available to merges video from various interfaces, video from various sources and provide one or more outputs for broadcast or re-broadcast. Conventional broadcasting stations employ dedicated TV and Radio transmitters and production studios and audio/video mixers to create the content stream that is then broadcast over-air. By employing the same practices and incorporating the functional elements of the infrastructure them into a compact hardware form, the local Hybrid Communication Node 99 broadcast area served by using a Broadcast TV modulator (not shown) along with a Broadcast Antenna 802 requiring much less transmission power than a conventional broadcasting station transmitter serving a large area. In addition, each Hybrid Communication Node 99 in a distributed telecommunication network can be used a separate TV/Radio station complex serving individual customer groups if required, and therefore the content being transmitted from the various stations does not necessarily have to be the same.

Wired Network Interfaces

The node 99 is able to handle wired networks by utilizing one or more wired interfaces 46. For the purposes of sending and receiving data communications through wired networks based upon copper interconnections, a Hybrid Communications Node 99 can employ numerous (typically 4-6 in number, though could be more or less) Local Area Network interfaces 469 that are both tightly integrated with the Watchdog Fault Management and Disaster Recovery Facility 50, and connected to the Multi-purpose Communications Bus 40. The types of physical media that are supported by the Local Area Network are shielded/un-shielded twisted pair wiring and coaxial cable. Ethernet network communication standards can be employed on wired interfaces so that the Hybrid Communications Nodes 99 can inter-operate with other Ethernet devices.

Local Area Network interfaces 469 in the present embodiment are preferred to be based upon a star topology interconnection scheme with other network nodes. Accordingly, the Hybrid Communication Node 99 has an optional in-built Ethernet hub or an Ethernet switch supporting CSMA/CD (Carrier Sense Multiple Access with Collision Avoidance) protocol and IEEE 802 LAN Standards. In this scenario, all of the physical connections/circuits from nearby networked devices connected to a particular Hybrid Communication Node 99 are routed back to its particular physical location. However, such Local Area Network interfaces can also be based upon a bus-topology.

A coaxial cable can be provisioned to function as a single physical cable acting as CSMA/CD trunks to carry communications traffic between multiple network devices simultaneously throughout the trunk/bus, thereby allowing the Hybrid Communication Nodes 99 to be placed relatively far (maximum: 305 meters) apart and be directly connected to other networking nodes at high speeds with other types of wired and wireless interfaces simultaneously.

The interfaces can also be networked by having RS-422 communications standards for wired connections as the physical layer as opposed to using current Ethernet standards (which have a distance limitations such as 500 m for IEEE 802.x using thick co-axial cable, 185 m for IEEE 802.x using thin coaxial cable, 100 m for IEEE 802.x and 802.y using unshielded twisted pair cable). To exceed these distance limitations, data communications are sent through serial high speed, balanced interconnections utilizing copper wires and conforming to RS-422 and related standards RS-449, RS-530 which can be adapted by hardware and software protocol converters to deliver up to 10 Mbps over 4000 feet (1200 m) between interfaces. This method is best suited for short range, wired interfaces.

Digital Subscriber Loop (DSL) modem interfaces 64 (FIG. 4) can also be used when plain copper pair wires are available that are only suitable for voice grade telephone traffic. The modem interfaces operate a mixed voice-data network over a limited range at high speeds. The voice/data splitter of the DSL modem allows the simultaneous transmission/reception of two-way conventional telephone voice services (i.e., from an analog telephony interface), as well as high speed data network communications in parallel, without affecting one another on the same physical circuit. A DSL Access Multiplexer (DSLAM) can also be provided within the Hybrid Communications Node 99 to manage the network traffic effectively, especially where many DSL modem interfaces are employed.

An asynchronous dialup modem can be also be provided within the Hybrid Communications Node 99. The dialup modem establishes a dialup network service to an Internet Service Provider (ISP). The dialup modem is especially useful to connect with a Public Switched Telephone Network connection with a voice-grade telephone service.

A matching serial data interface can also be provided in the Hybrid Communication Node 99. This interface is particularly useful to connect with an external network connection through a network terminal that has a Data Communication Equipment (DCE) in either Asynchronous or Synchronous serial interface.

Radio Interfaces

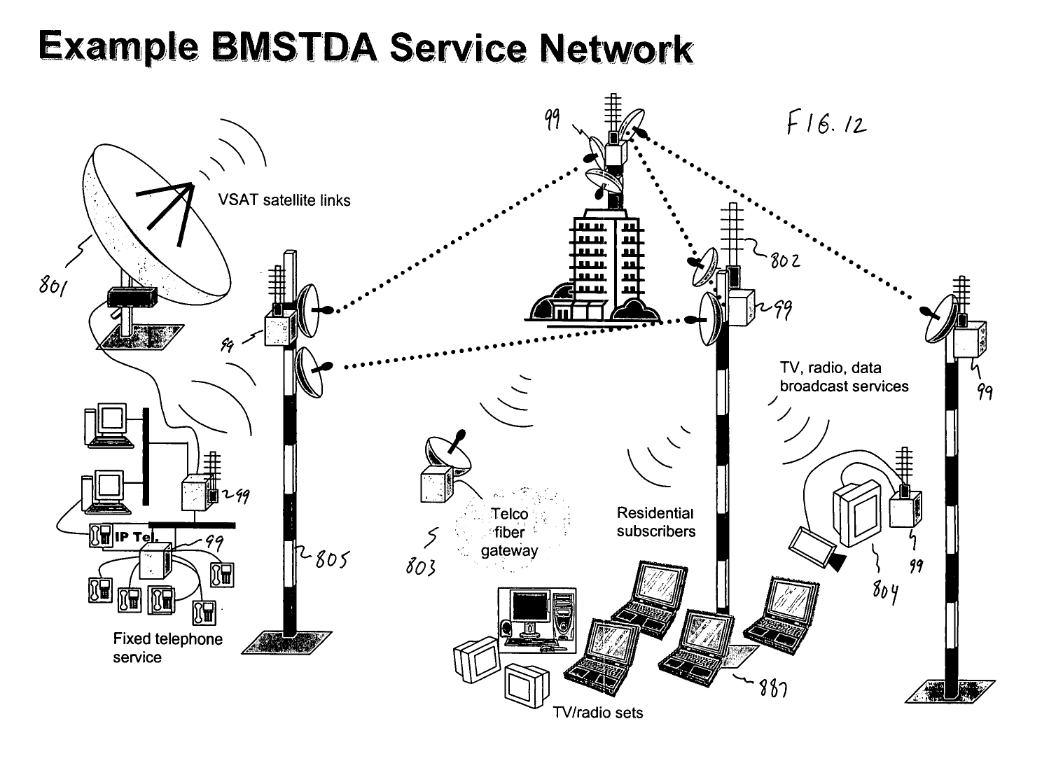

The node 99 can also include one or more radio interfaces 47. The radio interfaces 47 provide a communications network and broadcast coverage over either a long distance (30-50 Kilometers) or a wide-area (approximately 1000 sq. Kilometers) or both long-distance and wide-area coverage. The radio interfaces 47 can be used to directly deliver communication services to a customer, or as a communication channel to connect two or more Hybrid Communications Nodes 99 in a wide-area network. An example of a communication service directly delivered to a customer could be seen in FIG. 12, where residential subscribers 887 with computers equipped with wireless interfaces obtain connection to a remote Satellite Earth Station 801 through a series of interlinked networks composed of radio and wired interfaces.

Radio Interfaces 47 used in the present embodiment of the Hybrid Communications Node 99 work in particular bands of the radio spectrum and employ a particular method of modulation and encoding/decoding data. Some examples are Direct Sequence Spread Spectrum transceivers working at 2.4 GHz ISM Band Spectrum, or Orthogonal Frequency Division Multiplex transceivers operating also at 2.4 GHz ISM Band Spectrum. Additional Radio Interfaces 47 are also available that can provide Direct Sequence Spread Spectrum in the 900 MHz ISM band spectrum for example. In order to accommodate the change in global allocation of licensed/licensed radio spectrum, radio interfaces 14 can work on multiple frequency bands, and if needed, multiple frequency bands simultaneously.

In addition, radio interfaces 47 can be used that have software programmable modulation techniques so that the radio signal being emitted from the radio interface 14 can readily adaptable to a variety of communication data rates and communications protocols. A brief example may be for a radio interface 14 to be used for point-to-point communications services, and during a natural disaster emergency, be converted to be used as a mobile telephone base transceiver station interface, or converted through new software to a radio transmitter for providing public safety broadcasting information.

A variety of types of radio interfaces 47 are available for use in the Hybrid Communication Nodes 99, from simple narrow-band, point-to-point, synchronous radio links, to complex direct sequence spread spectrum radios providing broad-band service. Preferably, the radio interfaces 47 are either one-way or two-way in operation, either they are point-to-point or point-to-multipoint, either fixed frequency or frequency-agile, either modulated carrier or spread spectrum multi-carrier and that the transmit and receive carriers either share the same antenna or use different antennas.

By using different antennas for different receive and transmit antennas, interfaces can work at much faster data speeds. By using low-frequencies such as VHF/UHF band signals, broadband communication services can be delivered in dense urban environments and penetrate into buildings much more efficiently, at the expense of a lower-limit to the overall capacity of the communication channel. Since access to the customer is paramount, and the needs of subscribers vary from 128 kbps to 10 Mbps only on occasion, Hybrid Communication Nodes 99 use radio interfaces 47 which are optimized for multi-frequency operation and support the Failsafe Message Channel feature. The interfaces 47 can exchange very low-bit rate data information (for signaling, telemetry, remote command and control purposes) between each other's location even though the interface may be not in actual use by a Hybrid Communication Node 99.

The inclusion of several (typically 1-4) radio interfaces in the configuration of a Hybrid Communication Node 99 raises several issues. To avoid interference between the radio interfaces, which are co-located with each other, the adjacent radio interfaces 47 are placed in a manner that the output of each radio is shielded from each other. In addition, the outputs are carried through miniature flexible waveguide so that their respective signals do not interfere with one another and are fed directly to the antenna 21. The antennas 21 are also separated from one another by a considerable (typically 1-3 multiples of wavelength of the frequency being used) distance on a tall structure such as tower 20 or 805, and are placed in a manner so that each antenna in operation has separate and non-overlapping radiation patterns.

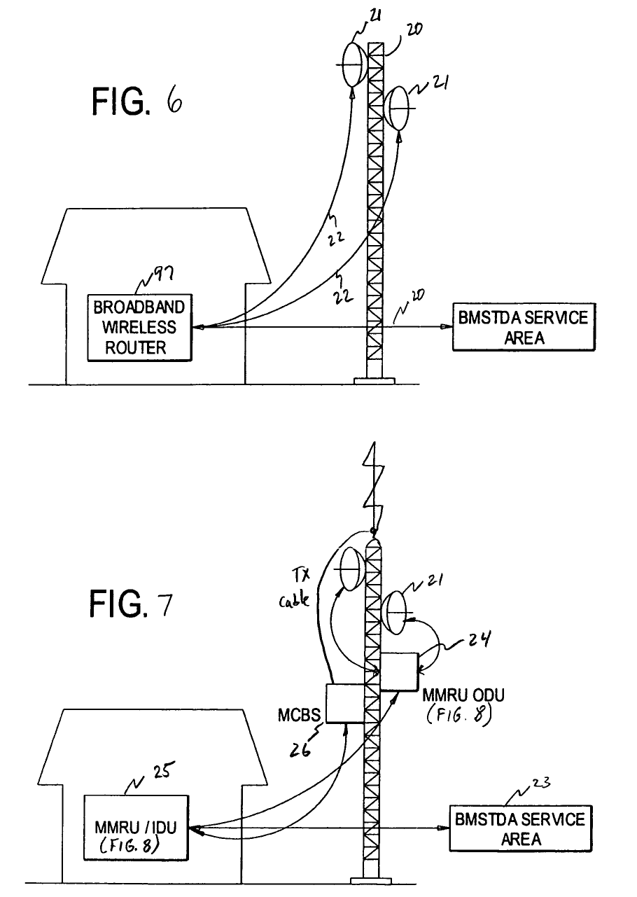

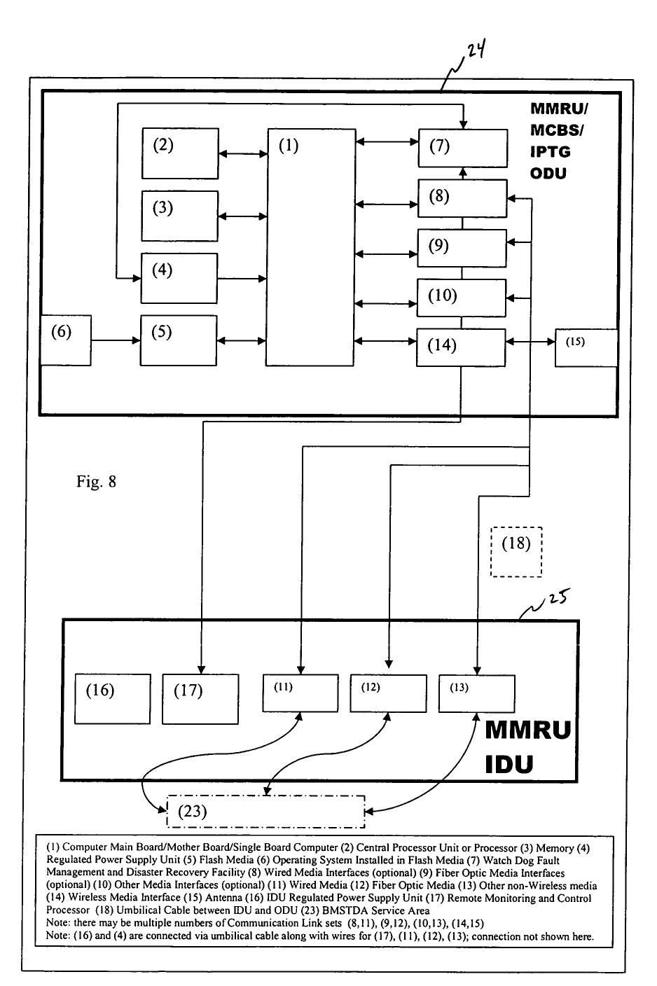

The system is optimized to obtain the lowest possible RF signal loss for each radio interface 47. With reference to FIGS. 7 and 8, the functions of the simplified node BWR of FIG. 6, are split into two parts entitled IDU (Indoor Unit) 24 and ODU (Outdoor Unit) 25. The ODU 25 is placed in a hermetically sealed and shielded enclosure and placed directly attached or very near the antenna(s) 21. The IDU 24 is typically affixed near the ground level of the communications tower/post 20 or placed within a habitat. The enclosure of the IDU 24 basically houses a regulated power supply 16 which works to provide regulated DC via the Umbilical Cable 18 to another regulated power supply 4 situated within the ODU 25 chassis. While the IDU power supply is currently used in the present embodiment of the invention, it is likely to be deprecated over time, as power can always be delivered directly to the ODU through the umbilical cable 18, if so desired.

Steps have also been taken to avoid signal loss due to the distance between the transmitter/antenna and receiver/antenna. By observing the placement of the BWR in FIG. 6, the RF output power delivered to the antenna 21 is less than what was delivered at the beginning of the cable. All coaxial transmission lines 22 or RF waveguides exhibit loss of some amount of RF signal which may vary according to the particular carrier frequency being used, and also the physical materials used in construction.

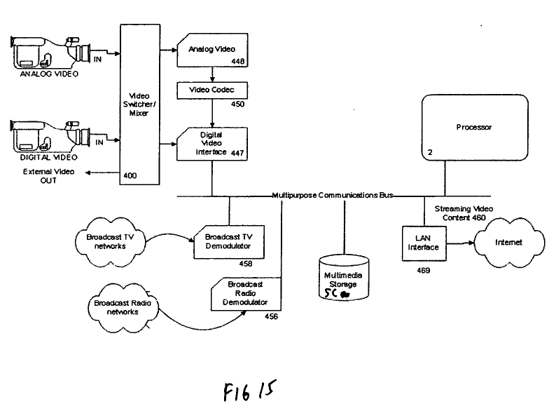

In the direction of antenna 21 to the receiver portion of the radio interface being used, similar loss characteristics are observed unless the receive frequency is lower or higher than the transmit frequency. While a two-part bi-directional RF amplifier with DC power injector 4781 as shown in FIG. 16 is commonly used in the industry to boost the signal output from the BWR or similar device to the antenna where the final stage is connected to the physical antenna, it is cumbersome and expensive. The IDU/ODU configuration (FIG. 7) is a more affordable and flexible approach than the BWR configuration (FIG. 6).

By adopting the ODU/IDU configuration model for all BMSTDA point-to-point links, a large gain is achieved in the radio link budget which denotes the available total system transmit and receiver power (measured in dBm units) on both sides of the RF chain in both directions. For example, a typical wireless LAN adapter may be utilized to put out 200 mW (23 dBm) RF output signal. Normally, that signal would barely travel a few hundred meters before being absorbed into the surrounding environment.

However, the Hybrid Communication Node 99 can directly pass the signal of that WLAN card (without loss) to a 24 dBi grid parabolic antenna, which results in a signal that travels as far as 30,000 meters if the antenna is fixed at a point between 60 and 100 feet above mean sea level on both sides. The data rate which can be achieved in this ad-hoc point-to-point network depends upon the various wireless LAN or radio adapters being used, and the general link budget calculations are based upon a formula which is: power measured by sensor at Transmitter Output Port (in dBm) units less; Transmitter Coaxial Feeder Cable or Transmitter Waveguide Loss (in dB units) plus; Transmit Antenna Gain (in dB units) less; Free Space Loss (in dB units) less; Signal Loss over the long distance path due to atmospheric factors (in dB units plus); Receive Antenna Gain (in dB units) less; Receiver Coaxial Feeder Cable Loss or Receiver Waveguide Loss (in dB units) less; Miscellaneous coupling losses in dB units=Received Signal Strength (in dBm). The difference between the Received Signal Strength and the required minimum sensitivity of the Receiver has to be measured and predicted accurately to ascertain whether a Hybrid Communication Node 99 can connect to a remote other node 99 at broadband connection speeds if a Radio interface 47 is used.

For broadcast or point-to-multipoint links, significant gain is achieved in the outbound path as well as the inbound path due to the elimination of any loss that would otherwise occur from the use of a coaxial transmission cable by employing an IDU/ODU configuration as per FIG. 7. If a particular radio interface 47 has many stages and a large number of components (and thus cannot easily be placed directly co-located to the antenna), the system may be physically split into several parts to accommodate the mounting requirements and requirements to prevent electrical interference between the components themselves.

As shown in FIGS. 6-8, the physical output stage of each of the radio interfaces transmitter are co-located directly with the antenna or through a very short waveguide or coaxial cable. This is done to maximize the range for a given low-power radio transmission signal from the radio interfaces 47. By delivering the maximum amount of RF power from one side of a network to other side, the signal is sent with as much as “less” loss as possible. Hence, directly attaching Wireless LAN adapters and Radio Modems to antenna is important to the BMSTDA implementation.

Antenna

Most of the functionality of the node 99 is to deliver broadband communication services over wide-area and long distances, efficiently. Antennas with different polarizations (Vertical, Horizontal, Left Handed Circular, Right Handed Circular) are used to prevent interference from adjacent radio interfaces 47 by maximizing isolation between the signals. Additional separation of the various RF signals can be obtained by placing the signals on different bands of the RF spectrum to avoid harmonics of the carrier frequencies and intermediate frequency mixer products which are considered spurious emissions.

Referring to FIG. 5, an automatic antenna positioning system 200 is shown for automatically positioning a panel antenna with adjustable baffles 202 mounted to a pole or tower 206. Conventional short range antenna have a wide-angle radiation pattern and are usually a panel antenna or omni antenna, whereas the conventional long distance antenna is a grid or solid semi-parabolic dish with a Yagi antenna in linear or circular polarization. Moving baffles to adjust the radiation pattern and look angle, rotating Azimuth and Elevation Mounts to adjust the horizontal coverage and vertical coverage are provided. Antenna 208 shows the moving baffles having an acute angle to each other and hence the radiation pattern will have a narrow beamwidth area and serve longer-range distance, but in a narrow conical slice of a town/city/urban area.

Conversely, antenna 210 shows the baffles opened considerably and the angle produced is obtuse, so that the resulting radiation pattern is extremely wide (<180 degrees) and the range covered will be significantly less. However this antenna then can be utilized to provide sectoral coverage of a town/city/urban area for broadband applications. A motor 204 is provided to control positioning of the antenna 202 in both the horizontal and vertical directions. The movement of the antenna can be controlled manually or by remote control of the Operating System Environment. In the FIG. 5, the presence of a Hybrid Communication Node is not explicitly shown due to the scale of the picture, but in order to serve these three antennas, it would be equipped with three independent radio interfaces.

Optical Network Interfaces

As further shown in FIG. 3, single-mode or multi-mode optical interfaces 41 are provided to connect the Hybrid Communication Node 99 with fiber optic cable media such as single mode glass, multi-mode glass, and plastic optic fiber. Preferably, one interface 41 is provided for each fiber optic cable so that the Hybrid Communication Node 99 can connect to other network devices as far as the optical cable can be extended with fiber optic repeaters at very high broadband data rates. The fiber optic network interface 41 is attached directly to the multipurpose communications bus 40 to eliminate any latency as it is a very high speed bandwidth relative to all other types of interfaces used in the Hybrid Communication Nodes 99.

For applications over a short distance, a very high data rate can be achieved when a clear line of sight is available, by using a free-space optical transmitter and receiver interface. The digital data from the multi-purpose communication bus 40 is converted into a synchronous sequence of light pulses and transmitted in the near-visible spectrum to a corresponding receiver on a Hybrid Communication Node 99 or a stand-alone Free Space Optical receiver approximately 2-3 Km away which has to be clearly visible and an obstruction free line-of-sight path.

Power Management Facility

The intelligent regulated power supply 52 is connected to either an external primary power supply 1001 (FIG. 3), an external secondary power supply 1002, its own optional internal rechargeable battery power supply 1003, or an optional external battery supply 1004. The power facility 52 is tasked with the responsibility of providing conditioned power to all of the system components of the Hybrid Communication Node 99 and can manage the power consumption by turning off/turning on when commanded by the Watchdog facility 50. The power facility 52 works closely with the Watchdog Fault Management and Disaster Recovery Facility 50 to realize energy efficiency, good management practices, baseline performance.

Referring to FIG. 3, the power management facility 52 powers all of the interface modules 41-47 and processing modules 1b, 50, 54 of the node 99. The power management facility 52 has a built-in battery backup. The power manager 52 selectively turns individual modules of the node 99 on and off and monitors the power usage of the node 99 in order to ensure that the node 99 stays in service in the event that the main power supply 4 fails. If required, the Power Management Facility 52 turns off one or more non-essential elements such cooling fans, indicator lights, inactive network interfaces, in conjunction with the Watchdog Fault Management Facility and Disaster Recovery Facility 50 through the Monitoring and Control Communications Facility 56.

Since this Communications Facility 56, is an independent sub-system prior to Watchdog Fault Management and Disaster Recovery Facility, the node 99 can continue to send its power availability and reserve (if any) status through Failsafe Message Channels 39 in order to notify other Hybrid Communication Nodes 99 of its condition so that they can relay it to the necessary repair and support group of the network operator who maintains the Hybrid Communication Nodes 99. In addition, all non-essential network traffic will be curtailed sharply and connectivity to only essential destinations will be allowed on a pre-assigned traffic priority basis.

Monitoring and Control Communication Services Facility

The Monitoring and Control (M&C) communications facility 56 employs a communication protocol which communicates with other Hybrid Communication Nodes 99 that are accessible through the network interfaces that are active. If nearby nodes are not known initially by a Hybrid Communication Node 99, a discovery interrogation packet is sent out so that other Hybrid Communication Node 99 can receive that packet and respond to it with its location and service related information directly back to the sender.

The facility 56 can also directly injects messages compatible with the communication protocol into the communications stream being sent out of any active interface 41-47. For this purpose, a separate communications path called the Failsafe Message Channel 39 is provided to connect each communication interface 41-47 with the Monitoring and Control Communications Facility 56. The Failsafe Message Channel 39 is apart from the regular connection to the Multi-purpose Communications Bus 40. The primary objective of the FailSafe Message Channel is to ensure a reliable, bullet-proof, low-capacity streaming data link (typically <9600 bps) between partially inactive and disabled Hybrid Communication Nodes 99.

Another advantage is that it can be used as a ways and means of exchanging out-of-band system health messages from node to node. Since it works directly with transceiver interfaces, it is independent of the system operational status. As long as the interface is correctly powered up and operating, the Failsafe Message Channel will be accessible.

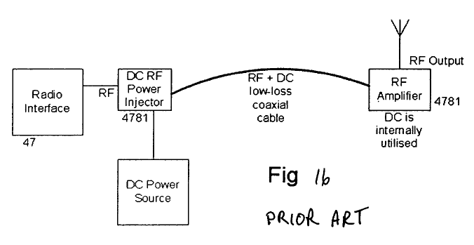

The Watchdog Fault Management and Disaster Recovery Facility continuously monitors sources of alarms. As shown in FIG. 17, the major sources for alarms are SNMP Traps or Alarms received over the network from other Hybrid Communication Nodes, Hardware Alarms representing any events that have happened/are happening/may happen inside of the Hybrid Communication Node, and Software Alarms from the Operating System Environment applications and module. The alarms are compared to existing nominal performance parameters and established practices and if out of the ordinary, then remedial action is taken including turn on/turn off the modules, exchange communication with foreign nodes for a graceful handover of services, etc.

Watchdog Fault Management and Disaster Recovery Facility

The watchdog facility 50 is an entire sub-system within the Hybrid Communication Node 99. The watchdog 50 works in tandem with the Monitoring and Communications Services Facility 56 to constantly monitor, record and report on the performance on all the internal functions of the Hybrid Communications Node 99.

All of the interfaces 8-10, 14, and 41-47 are managed by the Watchdog Facility 50. The interfaces 8-10, 14, and 41-47 each have a common failsafe message channel which can be addressed according to the interface name/id on the bus. and they are powered in turn powered by the Power Management Facility 52. The advantage of this feature is that there are alternative means to communicate to/from the Hybrid Node 99 in case of system failure.

The combined facilities 50, 56 allow the Hybrid Node 99 to take remedial action to recover from a minor or major error due to either hardware, software or external reason such as the loss of a signal on any interface from a remote device, network congestion, and conflict of network resource.

The watchdog facility 50 also follows authorized orders from other network devices if so commanded. The authorization will be matched to a pre-loaded list of known required authentication tokens updated from time to time. The watchdog facility 50 is functionally independent and separately designed using different electronic components from the rest of the Hybrid Communication Node 99 processing hardware. The watchdog 50 can command the Power Management Facility 52 to selectively turn on or turn off the operation of all major or minor modules of the Hybrid Communication node 99, including itself and the Power Management Facility.

The watchdog facility 50 can also turn itself on according to predetermined events or abnormal events that warrant attention. As an example, consider a natural disaster that has caused wide spread damage to the surrounding environment, and that power is not expected to be reliably restored. The Watchdog and Power Management modules which switches to fail-safe operation techniques to conserve whatever power is available in the reserve battery or if it has, an external power source. If however, the regular power has not been restored within a pre-set time, system turns itself off completely (by issuing a processor halt command) and enable an extremely low power consumption “watchdog” timer that will “wake-up” the system periodically over a long time span so to monitor if the regular power has indeed been restored.

Primary, Secondary Tertiary Storage

The storage 5 is a Non-Volatile Erasable and Re-writeable Memory having a primary region 5a, a secondary region 5b and a tertiary region 5c. The storage 5 stores the software programs used to operate the Hybrid Communication Node 99. Preferably, the three regions 5a-5c are physically distinct hardware in the node 99. However, the primary storage memory 5a can be kept separate from the secondary and tertiary storage memory 5b, 5c. This is to provide extra reliability if a Hybrid Communication Node has to be placed in a mission critical environment.

The primary memory storage area, which could be similar to a flash media 6 of FIG. 2, also seen as 5a contains the current Operating System Environment and the secondary memory storage 5b contains an older version of the Operating System Environment as a fallback option. The tertiary storage 5c should be larger than the Primary and Secondary storage areas 5a, 5b combined since the tertiary storage 5c is used to keep archival copies of system log data, older versions of the Operating System Environment programs and other utilities. The Processor 2 determines which storage area to obtain its program during startup after its inspects the contents of the primary and secondary storage areas 5a, 5b in order and calculates the checksum and determine if the image is intact and useable.

Bootstrap Facility

The node 99 includes a way to recover from a catastrophic system failure or other disaster in which the contents of the primary storage area and secondary storage areas have been erased, or that they have not yet been loaded. Any of the network interfaces 41-47 (that are active and connected to the Watchdog Fault Management and Disaster Recovery Facility 50, Monitoring and Control Communications Facility 56, and the Failsafe Message Channel 39) can request and receive read/write access directly to the primary and secondary storage areas for seeding the memory with the program code byte stream necessary for regular system operation.

The process obtains permission to write into memory directly, and then writing a highly repetitive byte stream with adequate parity checks and checksums of the data stream that has been transferred. When at a later date/time the system attempts to start up using the regular method, those repetitive streams are inspected for accuracy and if no egregious discrepancies found, the system will accept the code as valid true, and start executing it. This feature is generally referred to here as Bootstrapping (generally reflected in FIG. 3 as element 58) and is only available when the main Operating System Environment is not loaded and the interfaces 41-47 have been connected but not put into service, as this is a disruptive and lengthy process. The method by which remote control is established through indirect communication channels (Failsafe Message Channel 39 is a low-bit rate service) will result in significant delay, but ultimately reliable fallback in case of emergency.

General Illustrative Examples

The following example of the invention are provided for illustrative purposes. For instance, the Mast-Mounted Microwave Router Unit (MMRU) is implemented by providing a hybrid node 99 which includes an industrial strength Single-Board Computer containing the processor, memory, storage and multipurpose communication bus elements required of the Node, and optional Wired Interfaces 46 and Radio Interfaces 47. Using a compact weatherproof metal cabinet, and up to 4 Radio Interfaces inside of the same cabinet, serve different long routes. When maintenance is required, the keyboard and monitor are attached directly from the ground based IDU to the ODU (i.e., node 99) which is placed at the top of the tower, directly attached to the antennas. A low-loss transmission cable can be used to minimize loss, but can be costly to purchase, install and maintain.

Operating System Environment

By adopting a software-hardware hybrid platform based approach (FIG. 3) to designing switching, transmission, distribution, routing, application service and multi-media systems and not purely a hardware based approach such as common networking hardware available in the consumer industry today, having a custom-designed router, the present invention provides greater flexibility in implementation and service. New features or configurations can be provided by upgrading the software, and the equipment can be reused for different configurations. For example, the Micro-Community Broadcast Station (MCBS) 26 and the Multi-media Terminal Server (MMTS), but can also be used as a backup to the BWR 19, BR, MMRU 25 and vice-versa. Accordingly, the network will remain functional until repairs can be made. Also, older generations of personal computer components can be utilized by recycling their parts into custom-designed BWR, BR, MMRU, MCBS, MMTS and IPTG.

The Broadband Router (BR) (FIG. 1) is based upon the Hybrid Communication Node 99 system architecture enabling switching, transmission, distribution, application services for Wired Interfaces only. The Broadband Wireless Router (BWR) (FIG. 2), is based upon the BR, with extra support for Radio Interfaces.

The Mast-Mounted Router Unit (MMRU) is a split IDU/ODU design of the BWR, with extra support for long range radio interfaces. The Micro-Community Broadcasting Station (MCBS) design is based upon the MMRU, with extra support for Broadcast TV/Radio Interfaces. The MMTS is based upon MMRU and BWR, designed with extra support for Audio/Video displays. The dedicated IP Telephony Gateway (IPTG) is based upon the MMRU for large number of subscribers in rural communities, but also a sibling of all nodes 99 as each has telephony modules built in.

The system can be deployed quickly and be immediately useable by network operators to provide broadband services to customers in a cost effective manner. The system eliminates the need for central offices and reduces the cost for deploying network switching “at the edge” of the public switched telephone network by increasing interconnections between the nodes at the periphery and implementing distributed switching and transmission between the peripheral nodes instead of giving to go and connect back to the central office switches. This effectively then means there is no need to have a dedicated backhaul anymore as all possible communication paths can now be used as optional backhauls.

The operating system environment is completely self-contained set of software modules and does not require any interaction with any central network device for its function. It handles the standard functions of a router or M U 25. In addition, it functions as a multi-headed network node 99 which is continuously exchanging data with other Nodes 99. It also monitors and manages network service alarms as reported by its Watchdog facilities 50 and potentially severe disruptions in service, internal and external power, and can assess its own system health and respond accordingly. The hardware modules utilized in the construction of a Hybrid Communication Node 99 can be replaced in the field by being selectively shut down, through software commands, physically removed, physically replaced and selectively turned back on without disrupting operations in any other module, that is, it will have hot-swap capability.

As shown in FIG. 1, the Hybrid Communication Nodes 99 include a primary processor 2, as well as secondary and tertiary processors 2. A first software component, Operating System Kernel, is loaded on the primary processor to handle many of the low-level I/O functions required to communicate with, and manipulate the hardware. The Operating System Kernel is responsible to discover (e.g., at load time, and at various times thereafter during regular operations), which particular hardware modules are present in the system. It also has the responsibility of initializing the hardware and bringing the hardware up to a ready-for-service state so they can be managed more effectively with subordinate software modules.

Primary Functions

The following software modules are available immediately after the Operating System Kernel on the primary and backup Processors is loaded, and are referred to as the set of Primary Functions: event log management, interface management, neighbor management, network management, routing and switching services management, and primary power management.

Primary power management—All internal hardware modules obtain their power source from the Power Management Facility 52, which is a highly regulated and controlled hardware module. The Facility 52 can choose between a variety of connected power sources which are Primary External, Secondary External, Internal Battery, External Battery and to provide power to external devices through a switched electrical connector. In addition, the facilities 50, 52 implement energy conservation rules in order to lengthen operation time when the primary and alternative sources of energies are unreliable or unavailable.

The power facility 52 relays its current health and condition and a report of any necessary actions that it has taken to mitigate failed components to other nodes 99 and any assigned network management station (not shown) used by the telecommunications network operator through the Failsafe Message Channel 39. The power facility 52 also provides power to any other device if so commanded through an optional switched power output connector (1005).

Interface management—This software module directly interrogates on a predetermined basis all network interfaces attached to the Multipurpose Communications Bus 40, determines their status and health of the communications link the interface is responsible for, and compares it to nominal long term performance parameters which are recorded and analyzed over time as part of log entry management. An additional task of this module is to manage the setup process that takes place during or after the initial connection phase (e.g., authentication before connection, exchange of configuration options and resources negotiation during connection) is controlled by the interface management module.

Neighbor management—Each Hybrid Communication Node is aware of the network topology in use from time to time, and has a ready assessment of the routing, switching capabilities and available destinations of the adjacent nodes it is directly connected to.

Network Management—This software module sets up an internal routing decision tree based upon the state of its active network interfaces, the networks that it is physically connected to and actively routing traffic to and from. In addition, it interacts with the Watchdog facility 50 so that during a catastrophic time when any communication link is knocked out for any number of reasons, it can provide information to the Watchdog to make a decision to route traffic through other network nodes to gracefully throttle back traffic flow in the direction of the failed network and to resume traffic when and if the disruptive network is healed once again.

Routing and Switching Services Management—Routing and Switching Services Management handles all non-voice related requests to the Hybrid Communication Node Operating System Kernel from any of the Interfaces (via Interface Management) if data needs to flow between similar interfaces. The Routing and Switching Services Management allocates system resources as needed to establish the shortest possible path between those interfaces. For switching of network traffic between dissimilar network interfaces, temporary buffers in system memory 3 are employed to momentarily store network traffic and then either encapsulate the traffic onto the destination network interface, or to translate the traffic to the required format of the destination network interface, whichever is appropriate to the task of delivering data accurately to its final location.

Where data is exchanged between interfaces of a similar type (i.e., where the interfaces recognize the same data format), the processor 2 determines that it need not make any conversion. Optionally, a direct electrical connection can be made between the physical interfaces that handling similar data formats or are otherwise capable of communicating directly. For switching traffic between dissimilar interfaces, thee data can either be converted or encapsulated where the destination network interface is used as a transit medium only.

All network traffic coming into or leaving the Hybrid Communications Node 99 possess a Source Header and Destination Header appropriate to the particular network interface concerned. In this manner, the Hybrid Communication Node 99 essentially operates as a router since its primary function is to deliver the network traffic to the next-nearest node 99 onwards to the final destination.

Memory Storage Management—After the Operating System Kernel is activated at startup on Hybrid Communication Node 99, this software module provides file-system record keeping and journaling services to any application or driver module requiring access to current software, archive software, log entries, performance data archives and network status message stores across the primary storage 5a, secondary storage 5b and tertiary storage 5c. A primary function of this software module is to ensure that the Memory Storage 5 does not ever fill up to the point that the system will not be able to operate by implementing a rotating deletion scheme on frequently updated log files that it continuously keep monitoring for uncommonly large activity.

Telephony services management (FIG. 13)—A complete telecommunications soft-switch with support for VOIP interfaces is included in the Operating System Environment. Additional support for analog telephony interface hardware, digital telephone interface hardware, cellular telephony hardware and their related time division multiplexed cross connects and switches is available as optional loadable software modules. Each Hybrid Communications Node 99 is treated as a separate telephone exchange having many individual area codes and support from at least 4 up to approximately 1,000 individual telephone physical telephone circuits. This is a number that can be efficiently delivered if a single DS3 (T3 USA, E3 CCITT/ITU) standard telecommunications bearer circuit were to be used to deliver trunked phone service.

However, since the actual subscribers of one individual circuit may be more than just one per circuit, enough system resources is always available to handle up to 9,999 individual telephone numbers. The telephony services management can accept calls, place calls, forward calls, provide voice mail features, provide interactive voice response, and text-to-voice features, and in an innovative arrangement act as a voice interface to the Operating System Environment. In this manner, the entire management of the Hybrid System Nodes 99 (and by extension, the entire network of Hybrid Communication Nodes) is able to be managed and operated with voice commands.

Or, the Operating System Environment can be programmed to provide two-way communication facilities to network operators by utilizing voice prompts instead of text messages or to send voice/text paging messages using an external communication network. In order to implement this interactive voice network management feature, a natural language synthesized text-speech and speech-text interface library translates audio phrases/phonemes into text for interpretation and converts text generated by the Operating System Environment to appropriate speech.

Broadcast services management—This software module includes three sub-systems: Broadcast Reception, Broadcast Transmission, Content on Demand. If a Hybrid Communications Node is used to relay existing terrestrial or satellite network video/audio content, then the received signal is processed and manipulated (converted, recorded, transcoded) into a format for storing in a digital archive and also (if required) at the same time into a format suitable for high quality digital transmission. Separate streams can be generated simultaneously for different functions and delivery over different networks, such as the example presented in FIG. 14. As shown in FIG. 14, Broadcast Services Management manages the process of reception, conversion and relaying of traffic, allowing an option to also if required, or desired, record live transmission onto Tertiary Memory Storage 5c for later retrieval and playback of content-on-demand.

Thus, digital video and audio content, for instance, can be streamed from network content servers and played out via on-air interfaces to either TV, Radio or both simultaneously. In addition, individual content, such as audio and video streams, can be played out independently from each other. Content that is received at the Hybrid Communication Node 99 from either the on-air interface (through the Demodulator interfaces) or through the network (via the multi-purpose communication bus) can also be converted to a recordable format and stored locally within the tertiary storage for later playback on demand. The storage/recall facility for Audio/Video content enables users to employ conditional access systems enabling true Video-on-demand or Audio-on-demand commercial services.

If transmission of existing digital content is required as requested by a subscriber of another Hybrid Communication Node's Content on Demand software module, the Content on Demand module retrieves the appropriate digital audio/video stream from its local or remote memory storage and then delivers that content to the Broadcast Transmission module for onwards transmission.

Event log management—When the Hybrid Communication Node 99 is operating under nominal running conditions, any exception to routine operation such as Bootstraps or network failures is noted and kept in a non-volatile log entry for at least 30 days, and after a number of days (typically 30/60/90/120/180/365 days), the log entries are deleted on a first in first out basis. The entries are stored directly in the tertiary onboard non-volatile memory 5c.

Secondary Functions

To aid in system recovery and efficient management, a different set of software services are also provided which operate within the specialized processor called Watchdog Fault Management and Disaster Recovery Facility 50 which provides similar but less capable processing power for a Hybrid Communication Node compared to the regular processor 2.

The functions available through the Watchdog 50 are referred to as the secondary functions, as they have limited capacity and are designed to be used for emergency situations for extended periods in all circumstances. The programs in this section of the Operating System Environment are developed to higher software quality standards than the regular primary functions. Secondary functions include Secondary Routing and Switching Services, Secondary Power Management, Antenna Management, Fail Safe Message Services, and Bootstrap.

Secondary Routing and Switching Services—This module is responsible for all data and voice switching services including telephony and routing, and has the ability to allocate and manage bandwidth on all interface circuits so that during emergency usage, all circuits stay alive but operate at reduced capacity under all conditions. As an example, if the only link that survives is a 2 Mbps full duplex circuit in a network that used to be connected to many high speed links in excess of 45 Mbps, then all traffic that has to go through that single link at 2 Mbps is artificially and forcefully constrained to pass through that narrow link in a manner that no traffic is denied, but every is guaranteed less than optimum speeds.

New connections would be aggressively managed in order to conform to the new reduced network usage potential, and if required, the Operating System Environment will either send a voice/text message back to the sender of the traffic through the network or inform the originating network node of the reduced availability of network connectivity during the emergency operation.

Secondary power management—All internal hardware modules obtain their power source from the highly regulated and controlled hardware module called the Power Management Facility 52 which has a microprocessor controlled multi-pole switched mode power supply. The facility 52 can choose between a variety of power sources which are Primary External 1001, Secondary External 1002, Internal Battery 1003, External Battery 1004 and to provide power to external devices through a switched electrical connector 1005 from its own resources. When secondary power management is active, modules are provided with extremely low-power supply to extend life of any available source, and most non-essential functions such as fan, lights, speakers, will be turned off if not required or devices sent commands to turn off immediately and awake when required only. In this manner, survivability of the Hybrid Communication Node is guaranteed for many durations in excess of 7-10 days without any external power.

Antenna Management—This facility uses external sensors to detect and measure the RF signal activity at the antenna point and also monitors status messages generated from sensors attached to the radio network interfaces and guides the motorized azimuth-elevation mount in the appropriate direction so that it has increased gain in both transmit and receive paths. It uses the Monitoring and Control Communications Services Facility 56 short message protocols to attempt to communicate with the far remote node so that by exchanging informative low-bit rate short messages, basic verification/proof that the link communication can be established automatically or not, and implement a mutually negotiated protocol of tests, whereby without any human intervention two or more radio interfaces on Hybrid Communication Nodes 99 should be able to align their antennas as best as possible to each other.

This feature reduces the management requirements of network operators quite remarkably, as it would also allow the Hybrid Communication Nodes 99 units to be autonomous to a large degree and reduce the need to have engineers travel up to the communication tower and climb vertically to align with manual tools antennas to remote destinations.

During the initial phase of automated antenna alignment, the two interfaces mutually cycle through all common possible iterations of their radio interfaces for several attempts in order to find a combination of signaling method that would be mutually acceptable. If a match is not found, then the interfaces adopt a neutral setting which will have been determined at the time of manufacturing based upon the capability of each type of radio interface, which are normally default settings of the center of the frequency band the interface is programmed to be operating in at its very first configuration.

Fail Safe Message Services—This software module creates low-bit rate data packets to insert through the network Monitoring and Control Communications service facility 56, synchronization packets of information being exchanged with other Hybrid Communication Nodes 99 at the lowest levels of network interface connections through the Failsafe Message Channel which is a special mode of operation on all Hybrid Communication Node 99 interfaces. Thus, over a few time periods of physical layer activity, messages are exchanged with other nearby nodes and used as a very low capacity fall back link in case of emergency.

A few commands and queries are standardized across the network interfaces, which may be sent as coded bits according to the requirements and capability of the physical network interface being used. This service runs even without the presence of a processor 2 or any of the primary functions. If required, there is a separate mode of operation within each network interface which also allows the bootstrap facility to interact directly write Memory Storage to seed the system if required. Examples of the fail safe messages are shown in Table 1. The messages of Table 1 are an example only, and other types of Fail Safe Messages can be coded.

TABLE 1

{Node ID, My Status is }
{Node ID, I support Message Format }
{Node ID, Did not understand resend in Message
Format }
{Node ID, Give your Status}
{Node ID, Connection List Follows Next messages}
{Node ID, Connected to ; last
time ; traffic cap ; max
cap }
{Node ID, Set Mode to Secondary}

The communication protocol allow the node 99 to either report its status according to a predetermined schedule or when interrogated through an appropriate query. The reports are composed under normal operation by the Operating System Environment and its associated modules on an as-required basis.

Bootstrap—When required, an active Hybrid Communication Node sends a Bootstrap request with an authentication/challenge handshake to access the remote Node's memory storage 5 through the Failsafe Message Channel 39. A reverse bootstrap is possible, where a damaged Hybrid Communication Node senses failure of its own memory storage area and requests a bootstrap from its connected network nodes. The bootstrap process is shown in Table 2.

TABLE 2

{Node ID, Bootstrap Request}
{Node ID, Bootstrap Authentication Code
Challenge}
{Node ID, Bootstrap Authentication Code
Response}
{Node ID, Bootstrap Reason}
{Node ID, Bootstrap Begin follows}
{Node ID, Abort Bootstrap Reason}
{Node ID, Bootstrap Aborted}
{Node ID, Reverse Bootstrap}

Processor upgrading—In order to facilitate the upgrade of processing capability from time to time in the field where operational Hybrid Communications Nodes will be in service on a continuous basis, processing functions are distributed across multiple processors 2 that will be present in the system. The multiple processors 2 act as backups to each other in case one processor fails, the services can continue to function as the secondary processors take over. The Watch Dog Fault Management and Disaster Recovery Facility Processor 50 operates independently of all other processes, so that if processor replacement is required during the operation of a Hybrid Communication Node, the following methods allows the network to continue without interruption.

For instance, if one of the active processors 2 needs to be replaced, the watchdog processor 50 can be ordered to take the following steps. First, it enables Secondary Routing and Switching Services and Secondary Power Management in order to transfers control from Primary Functions to Secondary Functions, while providing continuity of service on all network interfaces and processes. It then disables power to the processor 2 needing replacement. The processor can then be replaced by a human operator and the replacement processor enabled. The replacement processor is then tested until verified using automated diagnostic routines, and is reset to synchronize functionality with the existing Secondary Functions. The replacement processor then reverts to the Primary Functions and disable Secondary Routing and Switching Services.

In another illustrative example of the invention, all of the active processors 2 can be replaced. Here, the watchdog 50 enables Secondary Routing and Switching Services, then transfers control from the Primary Functions to Secondary Routing and Switching Services. Power is then disabled to all of the processors, the processors are replaced and the replacement processors are enabled. The replacement processors are booted with Primary Functions, and tested until verified. The watchdog 50 then reverts from the Secondary Routing and Switching Services to the Primary Functions and disables the Secondary Functions.

Hot Swap—The Broadband Multiservice Switching Transmission and Distribution Architecture (BMSTDA) system implements “hot-swap” of the hardware in all of its devices. A dedicated and separate control line on the multipurpose communication bus is incorporated into the system mainboard to indicate to the processor 2 (and through it, to the Operating System Environment) that a new or replacement hardware item has been connected and that it is necessary to momentarily interrogate all devices attached to the system and verify once again what is connected and what is not. An abbreviated identification protocol and low-level interrogation protocol is used to identify the module and its requirements from the resource processor and system mainboard. One example of the logical path to connecting a new/replaced hardware module is shown in Table 3.

TABLE 3

{Hardware Module is not in slot yet}
slot is non-powered; is being monitored by
Watch Dog
{Hardware Module is inserted into slot}
Watch Dog monitors insertion and reports
Alarm to Kernel/Processor and elsewhere
Alarm is received by Kernel/Processor and
Interrogation inquiries are sent to slot
Unit responds with mission information,
configuration request and offer of software
module
Kernel/Processor responds and optionally offers
own latest software driver or accept unit's
current module
Kernel/Processor loads driver and authorizes
Watch Dog to power up slot
Watch Dog asks Power Management Facility to
report if power is available enable the slot
Power Management Facility calculates required
power and reports
If power is available, Watch Dog authorizes
Power Management Facility to enable slot for
operation
If power is not available, Watch Dog informs
Processor for further action.
{slot is powered up}
Hardware Module boots and accesses the
Multipurpose Communication Bus
Sub-ordinate driver software or software
modules interact with Hardware Module
through Interface Management
Hardware Module is ready-for-service

Thus, the communication nodes 99 need not shut down in order to “self-configure.” By separating operational functions into primary and secondary groups and the use of multiple types of inter-component communication and control methods, the hybrid communication node 99 provides mission critical service and significantly reduces the network operator's management burden since the node 99 is able to monitor, analyze and correct its own task

Broadband Multi-Service Switching Transmission and Distribution Architecture (BMSTDA) System

In accordance with a preferred embodiment of the invention, a Broadband Multi-Service Switching Transmission and Distribution Architecture (BMSTDA) is provided. The BMSTDA has the following characteristics: the communications technology solution is quick to implement; the communications technology is inexpensive to manufacture and implement, costing significantly less than standard switching, transmission and distribution solutions; the communications technology is broadband in performance; the BMSTDA is independent of any particular transmission method in use; the BMSTDA is able to use a variety of communications technologies in a hybrid manner; the BMSTDA uses a distributed, fault-tolerant, partial-mesh network topology to implement connections; the communications technology makes use of common-of-the-shelf parts and components as much as possible and should be interchangeable; the technology can be repaired in the field; the technology is built and designed taking note of the needs suitable for “zero-infrastructure” regions where it is likely that BMSTDA will be the first such communications technology to be introduced; the BMSTDA networks support multiple services; and, where radio links are used in a BMSTDA network, the least amount of signal is used in order to be legal as per local regulatory guidelines.

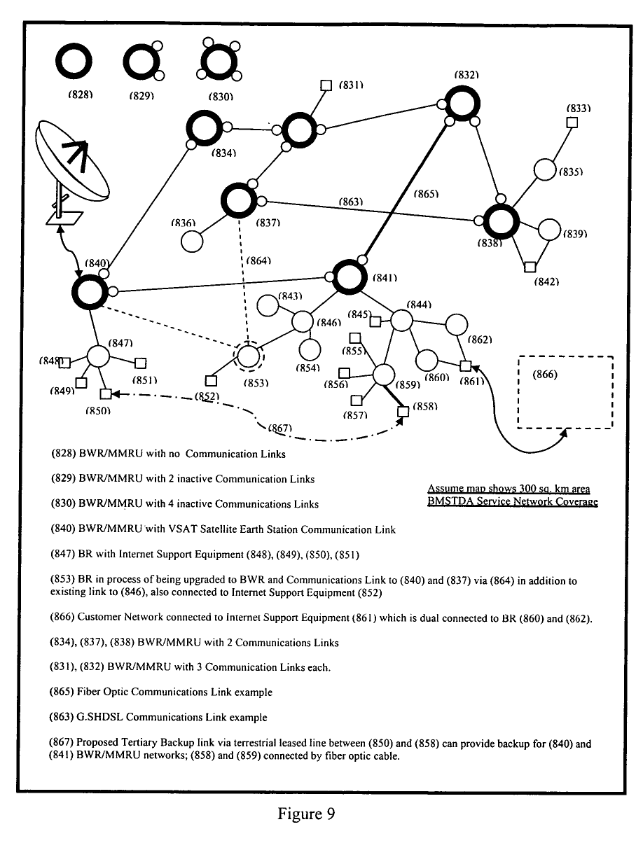

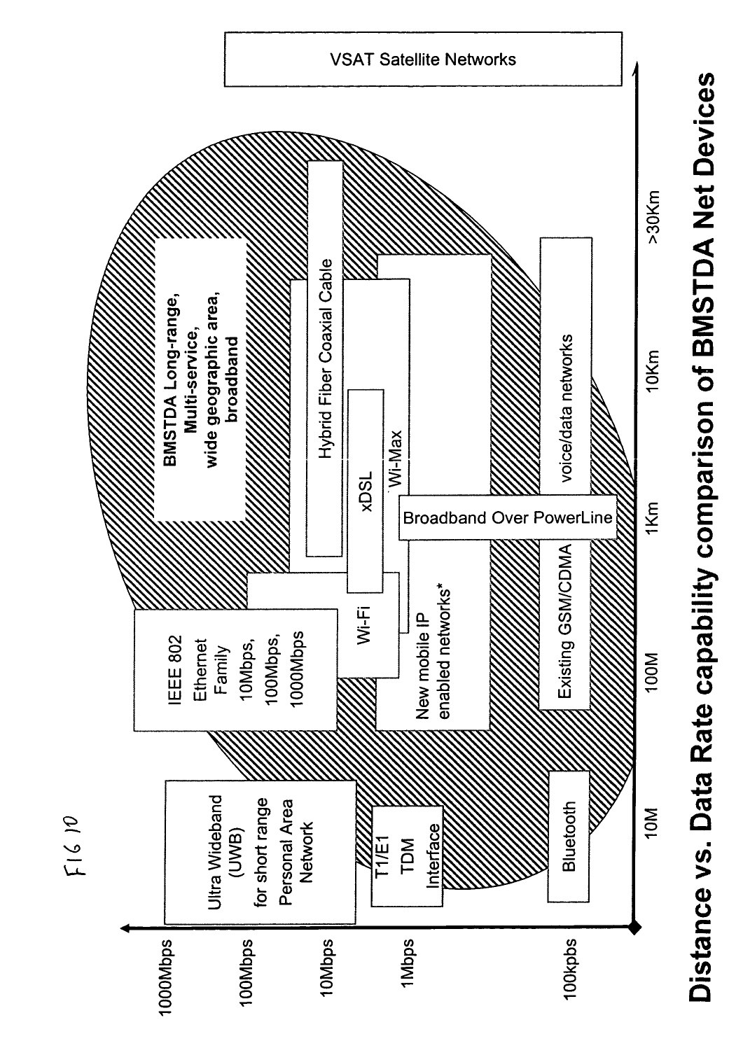

As shown in an illustrative embodiment of FIG. 9, the BMSTDA generally includes various Broadband Routers (BR), 847, 853 (shown in greater detail in FIG. 1) and Broadband Wireless Routers (BWR) 828-32, 834, 837, 838, 840 (shown in greater detail in FIGS. 2 and 6) which have Mast-Mounted Router Units (MMRU) with 0-4 communication links. In addition, the BMSTDA includes a customer network 866 connected to Internet support equipment 61, fiber optic communications link 865, G.SHDSL communications link 863, and a tertiary backup link 867 via terrestrial leased line to provide backup for BWR/MMRU 840 and 841.

The node 99 integrates the interfaces 8-10, 14 and 41-47 as part of a distributed communications network in which the individual hybrid communications nodes 99 are capable of serving their local service areas and connecting to other service areas via communication links and exchanging various forms of network traffic. In a BMSTDA network there is no need to have any centralized infrastructure anymore for voice/data/video/telephone switching, as all switching is performed local to the service area and the long haul transmission links (via the interfaces) are used as multipurpose communication trunks simultaneously for a variety of transmission needs.

An example of another current embodiment of a BMSTDA Service Network consisting of several varieties of Hybrid Communications Nodes 99 is shown in FIG. 12 where 5 (five) separate localities are connected to each other in a partial mesh network of broadband connections. A satellite earth station is connected via wired interfaces to Hybrid Communication Nodes 99 which then provides for its local area through other wired interfaces and services other communities via a wireless connection to a mast-mounted Hybrid Communication Node 99. Other areas in the region are connected by Hybrid Communication Nodes using point-to-point dedicated radio links but have the option of providing to their local connections either services through Radio Interfaces or Wired Interfaces, or both. It can be observed that video conferencing services are possible both through wired and wireless network methods.

The BMSTDA preferably utilizes common off-the-shelf components in its design and construction practices. An additional option on this system is to provide all connections to the keyboard and monitor input/output at the outside of the cabinet, not the inside of the cabinet, thereby making it possible to seal the unit after construction, assembly, integration and testing and also to prevent water seepage. Low-cost DC power supplies can be used instead of expensive Switched Mode Power Supplies to further reduce weight and manufacturing cost.

Turning to FIG. 7, one of the BWRs 20 included in the general BMSTDA network embodiment of FIG. 9 is shown, which can be used to service a community. As shown, an MMRU 25 is provided inside the building, which wirelessly communicates with an MMRU 24 located on the tower 20 adjacent the antennas 21. The MMRU 24 is a full-fledged community communications system able to serve local population with telephone and internet service, voice mail, fax (not shown), (not shown), TV, Radio (not shown) and provides the long-haul connectivity (typically 30-50 Km) required to establish a linkage to the Internet. In addition, a Micro-Community Broadcasting Station (MCBS) 26 can optionally be provided to provide TV and Radio Broadcasts services. Accordingly, the cable 22 of FIG. 6 is not needed. By eliminating the need to have hundreds of feet of RF Coaxial cable to connect the router to the antenna 21 also saves expense in implementation as well as gaining signal strength for longer range applications.

In the embodiment of the invention illustrated in FIGS. 5-7, the system and antennas 21 are mounted on a tower 20. However, the invention can be implemented without a tower 20. The system and antenna can be placed directly on the ground or small platform, so that a services can be quickly and easily set up in areas that lack standard telecommunications infrastructure, such as areas that have been devastated or which are impoverished.

In FIG. 7, the BMSTDA Service Area 23 is shown to denote, in this instance, all possible locations that can be connected through all types of wired interfaces. If all of the connections are telephony (as in FIG. 4), where subscribers are provided with copper cabling direct to their homes/businesses, then the service area would be on the order of 25 square miles area based upon traditional estimates of the length that telephony cable can be extended before the audio level is so low that it becomes unrecognizable.

As another example, for those subscribers who receive connections to distributed Ethernet infrastructure connected to high speed copper LAN interfaces from the same Hybrid Communication Nodes 99, the service area is far smaller and this LAN service area would be approximately less than 0.25 square miles in area, based upon LAN standard specifications of 100 m (Category 5 UTP Ethernet) with two repeaters each 100 m in various directions. A variety of wired and wireless interfaces 8-10, 14 can be simultaneously deployed. In addition, a GSM Mobile Cellular Terminal interface (not shown) can be provided and “telephony services” (not shown) matched so that remote subscribers of far away networks can place a call to the local Mobile phone network if so desired.

All terrestrial network interfaces are extended electrically from the ODU 24 to the IDU 25 via an umbilical cable 18 which may consist of copper cables and fiber optic cables or antenna feeder cable. The IDU 25 is essentially a low-cost aggregation point, whereas the ODU 24 is the unit containing the primary/secondary function group processing equipment and the actual wired, radio, optical interfaces. In this manner, the output of the radio interfaces can be fed directly to the antenna 21 with almost zero loss and the resulting signal gain over the conventional industry practice is used to deliver signals further away than previously possible, or utilized to provide extraordinarily powerful signals across the same distance as before, enabling efficient broadband operation.

In FIG. 7, the MCBS 26 and MMRU 24 configuration is shown. The MCBS 26 is an optional device which provides TV/Radio transmission services to a local area. The MCBS 26 is connected to the Mast-Mounted Router Unit (MMRU) 24 which provides the long distance connection service to the broadcasting station. This configuration is particularly useful for remote localities in urban and developing regions, where television transmissions would otherwise be very costly to broadcast over a very large area (say, 500 sq. miles).

The BMSTDA System

The BMSTDA can be implemented quickly and in a flexible manner. In developing economies and infrastructure poor regions, the BMSTDA system can deliver flexibility in the use of varied communications media (wired, wireless radio, wireless free space optics, fiber optics as well as satellite) and modular, re-usable designed to be serviced and repaired in the field. The invention is also inexpensive to implement and easy to upgrade and to expand when a new service point is needed. A minimum network size is not required before deployment can begin.

However, the BMSTDA system also supports complex IT applications in developed countries. Embedded versions of the BMSTDA can be incorporated into existing computer technology and intelligent connectivity can be enabled to legacy IT devices. In addition, existing BMSTDA equipment can be used to provide connectivity to rural areas where a disparity exists between those who have connectivity and those who do not. For example, in Australia, despite the main metropolitan cities being very well connected, the Outback areas of the continent are not well connected due to their extreme low density of users and far flung geographic coverage. This is an ideal area for a lightweight high capacity transmission, distribution and switching solution using the BMSTDA system.

The BMSTDA system maximizes geographic coverage and the number of users able to be connected at all times, at a minimal expense. The system is compatible with existing service area coverage, and the rate of growth to be achieved. The BMSTDA system delivers multiple data and voice services efficiently over long distances. The BMSTDA system is versatile enough to be used in the various communications market segments, including carriers, Internet service providers, cybercafé, telecenters, Internet telephony service providers, broadcasters (such as TV, radio, satellite DVB, satellite radio), fiber networks, WiFi access networks, PSTN, wireless local loops, and mobile phones. Network coverage can be expanded using any suitable communications media, at high data rates at low-cost. The same equipment can be re-used or updated as required, and can be used to connect several locations together in addition to acting as a customer premise equipment if so desired.

For instance, Internet Service Providers can expand their network easily, and Internet Telephony Service Providers can expand their network Points of Presence supplying voice services at a much lower cost than existing solutions, as BMSTDA offers better integration. In addition, satellite Radio and TV Broadcasters and operators can use BMSTDA technology to provide bi-directional feeds to/from a Satellite Gateway to remote broadcast/reception locations, or ask that a custom BMSTDA device be built that can communicate to the Satellite transponders directly in conjunction with terrestrial network facilities.

PSTN Operators, WLL Operators and Mobile Phone Operators can use the BMSTDA system to expand and re-configure their networks into more flexible, economic, low-cost alternatives to traditional telecommunications. Legacy resources can then be freed up and re-deployed elsewhere. BMSTDA can also be used with existing GSM and CDMA operators to offer secondary revenue earning possibilities by employing next generation of Spread Spectrum interfaces that operate within the same band and at the same time as existing mobile and paging networks without affecting the primary service whatsoever. This is possible since the radio interface can be configured for extremely low-power but wide-band direct sequence spread spectrum (DSSS) or orthogonal frequency division multiplexing (OFDM) and can be programmed to do avoid most of the known fixed carriers in use on that network. By this approach, the BMSTDA provides 11/54/108 Mbps/higher bandwidth and resource capability in the cellular market, and requires no additional spectrum licensing effort on the part of the operators already licensed to provide wireless services. As long as there are locations close to, but not directly in close proximity to, the BTS that can be used for MMRU or BWR implementation of BMSTDA, the two networks can coexist with each other and not interfere.

Within the surface transportation industry, there is an ongoing practice to outfit commercial vehicles and high-end consumer vehicles with communications technologies, such as GPS units tied to a tracking-reporting system and mapping system utilizing traditional cellular phone networks, and mobile wireless terminals accessing on demand data services from nearby fixed Wireless Access Points or Wireless Service infrastructure. The BMSTDA system offers an advanced platform to build applications on, as it offers “out of the box” solutions of connectivity, switching, and routing, And, in cases where there is little or no fixed terrestrial telecommunications infrastructure (such as, long highway stretches in the various countries or hilly/mountainous regions), the “Zero-Infrastructure” nature of BMSTDA enables networks to be expanded. It also enables cost-effective and flexible two-way broadband communication between nearby vehicles as well as nearby fixed telecommunications infrastructure.

The BMSTDA system can also be used in the Maritime transportation industry to communicate more effectively with small fishing vessels, pleasure craft, tour operators, and commercial and residential properties based around coastlines of a particular geographic zone. The system can easily be used in situations where neither the receiver nor the transmitter is on a stable platform (they may move with wind/wave/motion) and due to the inherent routing, switching and distribution capability of all BMSTDA devices, in a situation where many vessels are moored together or located in the same port and surroundings together they can act as a mesh network to allow universal communications including telephony, data, signals and warnings from meteorology authorities.

The BMSTDA systems can also be used in military communications since it is a versatile building block for man-portable wearable communications devices, tactical fault-tolerant communications networks, signal intelligence, autonomous hybrid communications nodes. It can also provide life-line and Public Safety communications as well as post-disaster ad-hoc instant communications setup where there are no surviving terrestrial or satellite communications facilities. The ranges of the existing devices are within 40 Km with special transmission facilities and about 25-30 Km without any extra equipment. Therefore, for a post-disaster relief operation, a suitable rugged, autonomous BMSTDA device can be air-dropped or manually placed to set up a remote communications station at a moments notice. Since the device is broadband, voice and data services can be provided with almost no delay and the device can feed video and audio streams back to the logistics co-ordination centers of relief efforts.

The BMSTDA system is particularly useful for telecommunications facilities in harsh environments typically found in subterranean environments such as the Mining or Under-surface transportation industry, as it is able to combine switching, transmission, routing in one platform and work as an intelligent controller without regard to other infrastructure.

The invention can be used both in the ground to provide versatile communications between fixed facilities at Airports and Maintenance facilities, as well as communication modules between aircraft in flight, as the network connection and disconnections and hand-over from region to region (during the flight profile) can be efficiently handled by the inherent processing facilities of BMSTDA devices.

Low-cost ICT devices using BMSTDA technology is also particularly useful to Educational and Health organizations. Both are service oriented, and face limitations on available resources against an increasing demand. The ad-hoc nature of the BMSTDA devices and the ease of use, repair, upgrade and modification makes it particularly useful in these environments. It is useful in developing economies as a low-cost approach to building networks at the grass roots level. And, it is useful in a complementary market to the Developing Economy and Infra-structure Poor regional market.

The BMSTDA system also has uses in space communications, meteorology, remote sensing and forestry. Orbital vehicles and space exploration vehicles can take advantage of the BMSTDA technology by incorporating multiple communications systems control and onboard local processing of communications traffic within a small payload that can be programmed to adapt to changing circumstances and environment. Space missions continue to require a wide range of communications methods between each spacecraft or between spacecraft and ground vehicles. Such a diverse application profile will have to be managed by smart, adaptable, hybrid communications nodes. The BMSTDA system is small in space, size and weight. For applications in remote sensing and return of meteorology data from LEO satellites, weather balloons or buoys floating on rivers or the ocean, BMSTDA can provide an advanced platform to build sophisticated applications for reliable environment monitoring.

For consumer applications, the BMSTDA system provides always-on or on-demand sophisticated communications services to Internet appliances, or basically any mechanical and electrical equipment that needs to be connected to the future communications networks. These include physical communications devices such as mobile phones, PDA, cordless phones, residential security controller, building HVAC controllers, process monitoring and control and programmable logic control.

In the computer industry, the invention enhances the portability and connectivity of desktop computers which are have been always tethered to a wall socket by means of a dedicated network cable of either 10 Mbps, 100 Mbps or 1000 Mbps raw data rate. Desktop computers (other than servers) rarely need or use the maximum capability of the bandwidth available at each network interface, such that the BMSTDA can introduce hybrid routing and switching functionality within the desktop computer (or any computing device) to connect it with multiple number of physical or logical network connections.

The BMSTDA processing sub-system is able to efficiently manage the multi-way communication needed to ensure the host computer never is left disconnected or has anything less than high availability on a network.

In order to build networks of Hybrid Communication Nodes, each device is preferably connected to at least one other BMSTDA device (or any other external non-BMSTDA device using a compatible communications protocol) and communications media. If two or more devices are co-located, they can be connected to each other with a simple LAN cable or other type of umbilical cable.

In addition to BR and BWR, other configurations are possible, without limitation. For instance, an MMRU IDU can house the main power supply and terrestrial connectivity interfaces, and an MMRU ODU can house the transmission, switching and distribution hardware including the processing hardware. The transmission loss is minimized and the effective range of the radio links increased by at least four to eight times the typical range of connections. The MMRU expands the capability of the BWR configuration by shifting the transmission point from indoors to outdoors (i.e., adjacent the antenna). Possible interfaces include, for instance, Ethernet, xDSL, Wireless Radio, Wireless Free Space Optics, Fiber Optics, and Satellite uplink/downlink. Like the BWR, the MMRU also can operate as a Wireless Access Point, if desired.

Another configuration of the invention is as a Multi-Media Terminal Server (MMTS). For instance, the MMRU system consisting of an IDU and an ODU can be used in a situation where a local community telecentre or a small regional operator needs to relay digital Audio and Video content to a conference room or a class room, while maintaining connectivity to external networks. The audio and/or video signal can be extracted and decoded from the appropriate streaming network data and delivered as a video signal and an audio signal to the appropriate local equipment which could be Television, Radio, Cable TV Head End, Amplifier, Video/Audio Switcher etc. Additional interfaces are provided to a basic MMRU system in order to process the digital/analog conversion, but otherwise the features of the MMTS mirror that of MMRU, BWR, BR devices.

As shown in FIGS. 7 and 8, the BMSTDA can include an MMRU with an optional MCBS. The MCBS provides a dedicated broadcast facility (for instance, a local community may be connected by an MMRU or BWR). With the addition of single or multiple low-cost analog TV transmission or analog radio transmission modules, the signals of the video/audio channels can be broadcast at very low operational cost to end user television and radio sets. For VHF TV signals and FM radio signals, the minimum coverage is 79 Sq. Km and average coverage will be 314 Sq. Km. For HF radio broadcast coverage, the minimum area coverage is 7,850 Sq. Km. The device functions similar to MMTS, MMRU, BWR, BR and uses the same communications interfaces.

As also shown in FIG. 8, the BMSTDA can include an IP Telephony Gateway (IPTG). By adding telephony software and hardware interfaces such as FXO, FXS, E&M, E1, T1 ports and intelligent telephony processing software, the MMRU operates as an efficient small scale telephony switch. Typically, 1-4 analog phone lines can be easily handled in a bare bones MMRU ODU chassis, or a BWR chassis. For higher number of ports, an external channel bank facilities, or a dedicated analog telephone port interface can be used in MMRU IDU units. Preferably, the IPTG configuration has either 30 Channels/24 Channels, 60 Channels/48 Channels, 90 Channels/72 Channels, 120 Channels/96 Channels. All other connectivity options and network management feature sets remain the same such as MMTS, MMRU, BWR, BR and if needed MCBS.

As still further shown in FIG. 8, the BMSTDA can include a Micro-Community Communication Node (MCN). The MCN is not a single device, but rather is a service network that provides applications and connectivity for an entire “small” area. The MCN is a reference to the concept of a “Community Communications Node” that acts as a telecenter in some villages in rural areas worldwide. A MCN is preferably set up in a small area serving several households or established schools or medical facilities. This is called Community Ownership of BMSTDA network infrastructure. By adopting local ownership practices, local youths can be employed to service and maintain this equipment, and the community support services can result in the community eventually owning their infrastructure.

Preferably, at least two MCNs are interconnected to form a “network”. To provide a fault-tolerant, partial-mesh service, each MCN is connected at the earliest opportunity to another MCN somewhere nearby to provide a redundant path back to other network nodes. A single MCN therefore can consist of any number of Hybrid Communications Nodes. In addition, to distribute connectivity, the network on the ground or in the air is spread out to reach various households, businesses, schools, hospitals, etc, in a urban setting. Preferably, a small size BMSTDA service area is 100 sq. km of coverage which may include many MCN in a network. A medium size BMSTDA service area is 500 sq. km of coverage which will include many MCN in a network. A large BMSTDA service area is 1000 sq. km of coverage which will include many MCN in a network.

With reference to FIG. 9, a medium sized BMSTDA service area of 300 sq. km is shown with a variety of Hybrid Communication Nodes (such as BWR/MMRUs and BRs) interconnected in a partial mesh network. Sample nodes are shown with no communication links, 2 communication links and 4 communication links in the top left corner. A VSAT Satellite Earth Station is shown as an example that a stand-alone network in a developing country or a rural region can be easily setup as long as there is connectivity back to a metropolitan area through satellite or other long haul trunk connection such as fiber optics. Several variations in Hybrid Communication Node configuration and type of connections including wireless point-to-point (e.g., BWR/MMRUs 40-41), wireless point-to-multipoint at Hybrid Communication Node/BR 53 (which is a nexus under development to a BWR where long distance links from BWR/MMRUs 37 and 40 arrive, wired Ethernet connections are provided to 52, short distance wireless link to 46), fiber optical connections between Hybrid Communications Node 59 and 58. In most cases, each Hybrid Node is connected to at least one or more nodes for redundancy purposes. This configuration would cover an approximately 300 Sq. Km area.

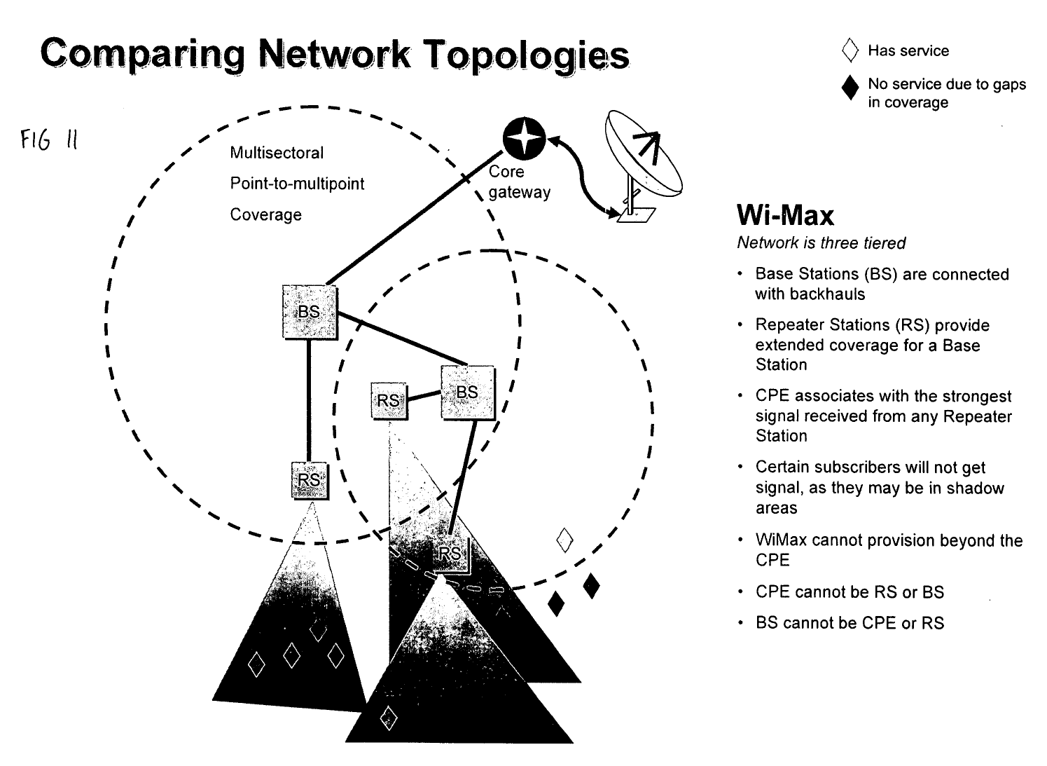

The invention distributes a complete suite of switching, routing, distribution, applications along with distributing the network connectivity in a format that is compact and manageable. The system can be miniaturized so that the entire Hybrid Communication Node package is a small integrated circuit complete with miniature versions of all of the required components with connections to external devices in the form of a multi-pin header. As shown in FIG. 10, the present invention encompasses a larger service area with appreciable network speed interfaces, very low speeds such as 2.4 Kbps to above 1000 Mbps and with coverage areas as small as 10 meters to as large as 60 Km. BMSTDA is designed to complete VSAT Satellite Networking where there is no infrastructure present, but services have to be deployed.

The BMSTDA network is able to provide equal performance to other network technologies, such as Wi-Max and Wi-Fi Mesh, at a fraction of the cost. For instance, the embodiment of the invention can be implemented in a service area (suburban area in Northern Virginia's Fairfax County) that is 4 square miles (4 miles by 1 mile) with geographically mixed terrain consisting of gently rolling hills and flat areas having built-out areas interspersed with wooded areas, concentrations of residential (70%) and commercial development and a representative mix of single family dwellings; mixed use, and multi-tenant buildings (apartments and strip mall style commercial development), with an estimated subscriber base of 3,000-3,500. A WiMax implementation would require 4 base stations and 1 repeater station. A Wi-Fi implementation would require 4 base stations for mesh backbone, 92 mesh nodes, 3 backhauls. The present invention, in contrast would require 6 Hybrid Communication Nodes in a partial mesh configuration. The capital cost to implement the present invention across this scenario would be less than 10% of the cost to implement WiMax, and about one-fourth of the cost to implement Wi-Fi.

Compared to Wi-Max, the present invention has numerous advantages including smaller and more versatile nodes which penetrate into the subscriber regions farther and with less cost. The present invention also utilizes less power since the transmission power is not lost from a central point such as a Base Station, and is delivered with more power to the antenna point due to the use of MMRU configuration.

Compared to Wi-Fi Mesh nodes, BMSTDA networks can be set up for far less number of equipment than Wi-Fi Mesh, which contributes to reducing the operating cost and management issues. Latency on the BMSTDA network is significantly reduced between Wi-Max and Wi-Fi because the radio links area bother literally and figuratively point-to-point using their individual radio channel. Therefore network congestion is avoided on BMSTDA networks as there are a plethora of alternative routes available to carry traffic back and forth, and routes will only carry traffic that is properly addressed to the relevant destinations. However selected types of networks can be “broadcast” to specific groups on the network, and due to the advanced hybrid architecture, each node will throttle the bandwidth provided on different interfaces to ensure regular network traffic is not affected.

Compared to both network topologies, the dedicated nature of the point-to-point links ensure that the BMSTDA hybrid communication nodes provide higher data rates in real world situations while utilizing the same spectrum allocation, and assuming all parties are using the same modulation parameters for their carriers. In addition, Wimax has the disadvantage of having shadow areas. As shown in FIG. 10, Wi-Max is a three tiered network, but is unable to cover extreme shadow areas as the transmitter station (Base Station) is itself fixed and unless another nearby (with overlapping service area) Base Station or Repeater Station is available, that shadow area will not be able to get service. Compared with FIG. 9, the BMSTDA is able to achieve much greater penetration.

The Out Door Unit Enclosure

Construction of the MMRU ODU 24 is shown in FIGS. 18-21. The ODU 24 is housed in an enclosure or housing 300 formed by an outer shell 302 and a cover 304, each constructed of a metallic alloy. The cover 304 has a top plate 305 and a divider plate 320 extending perpendicular from the top plate 305 to form a T-shape. The outer shell has five walls (four side walls and a rear wall) to form an enclosure with an opening at the front. The side walls of the outer shell 302 have ends which are bent into a flange 330 having through holes which align with respective openings in the top plate 305 of the cover 304. The through holes of the flange 330 cooperate with the openings in the top plate 305 to receive fasteners 306 around the periphery of the unit 24 to thereby secure the cover 304 to the outer shell 202.

As shown in FIG. 18, a gasket 332 is positioned therebetween to prevent moisture seepage into the interior section of the outer shell 302. The hole diameter for each of the bolts of the gasket are nominally larger than the holes present in the metal flange 302 or the cover 304 so that when the gasket 332 is pressed due to the insertion of screws into the threaded holes, the gasket is not trapped and has room to expand and form efficient air-pockets that are impervious to moisture ingress.

Guides 318 face inwardly at the interior of the outer shell 302, to receive the divider plate 320 of the cover 304. The width and length of the divider plate 320 is substantially the same as that of the interior section of the outer shell 302. To place the cover 304 on the outer shell 302, the divider plate 320 is aligned with the guides 318 and the divider plate 320 is then slid into the outer shell 302. The divider plate 320 thereby separates the interior of the shell 302 into two hermetically and RF shielded enclosures 321, 323, which are located on opposite sides of the divider plate 320.

The first enclosure 321 is proximate to the umbilical cable connectors 308 and the flash memory access panel 310 (which is bolted to the top plate 305 with a gasket therebetween). All high power devices, such as Power Supply, Radio amplifiers, and external power sources connections, are located within the second enclosure 323 and fed directly to the external RF connectors 312. The only access between the first enclosure 321 and the second enclosure 323 is through heavily filtered and grounded cables with sealing glands.

Support or mounting brackets 316 are affixed to the rear wall of the outer shell 302 so that the unit 24 can be mounted near an antenna support bracket on the communications tower/post 20 of FIG. 5. Rounded bar handles 314 are provided on the front exterior of the cover 304 to enable the user to insert and remove the cover 304 from the outer shell 302.

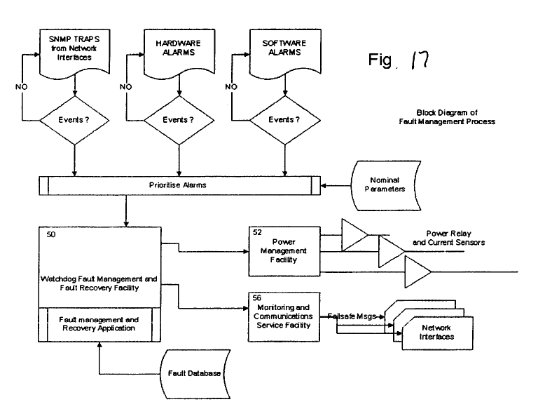

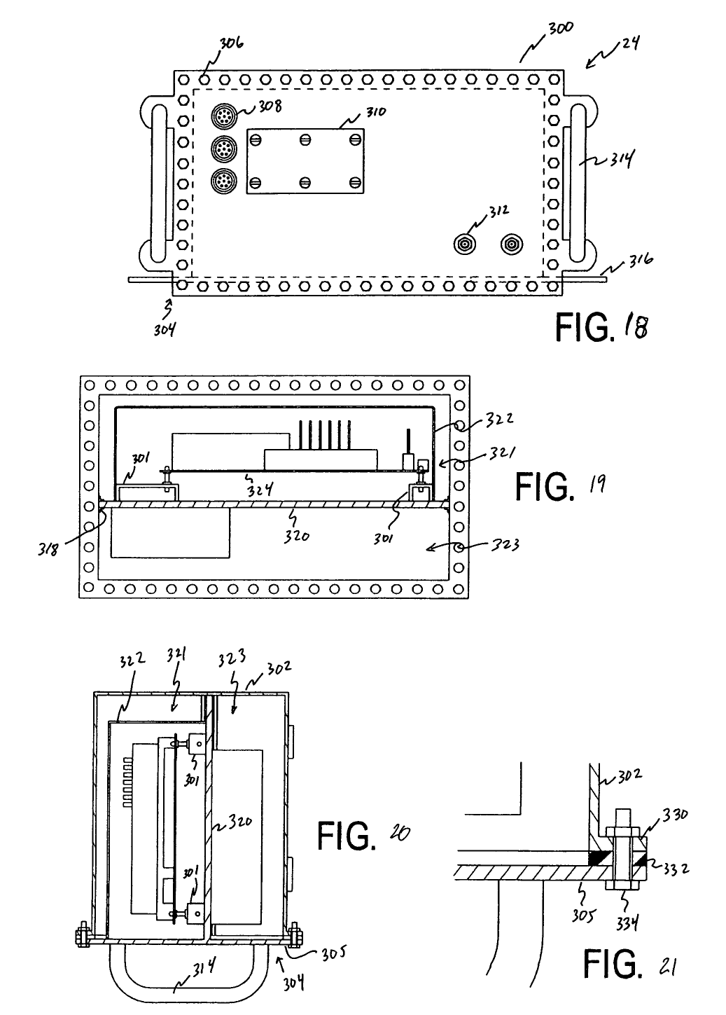

Support standoffs 301 are positioned on the divider plate 320 to support PCBs 324. A shield 322 is provided about the first enclosure 321 and removably attaches to the standoffs 301, as best shown in FIGS. 19-20. The first enclosure 321 houses the basic components of the Hybrid Communication Node 99 (FIG. 3). The shielded enclosure 322 provides extra protection against any RF or electronic interference from other devices and from its other components, such as the components located within enclosure 323. The umbilical cable of the ODU 24 which connects with the IDU 25 is mated with the appropriate connectors 308 and the cables are distributed inside the chassis according to the destination.

For instance, the umbilical cable can connect the Low Voltage DC power Primary to Power Management Facility, the Low Voltage DC power Secondary to Power Management Facility, the LAN1 to LAN Interface 1, the LAN2 to LAN Interface 2, the Monitoring and Control Cable to Serial Port, and the Power Monitoring return cable to IDU for monitoring purposes. Both the IDU and ODU have the same wires going between them.

Accordingly, the housing 300 provides a secure electrical and RF environment for hybrid communication services. The design is compartmentalized so that EMI/RFI interference between adjacent facilities is minimized considerably to negligible values. In addition, the enclosure 300 operates as an efficient Heat Sink, with thermal conductive surfaces for the heat to pass through as it is generated from the active electronic and radio components. Any heat generated is absorbed by the smooth metal enclosure surfaces and radiated outwards by convection method. The enclosure 300, when sealed, provides several barriers to moisture and dust ingress.

The assembly 300 is approximately 11.5 inches in length and 6.75 inches in width, though can be made substantially smaller in size. It is also lightweight so that it is portable and easy to transport (with a suitable antenna), install and repair. The separate access panel 310 allows the user to quickly replace or upgrade the system software stored on the Flash Memory Storage unit.

The foregoing description and drawings should be considered as illustrative only of the principles of the invention. The invention may be configured in a variety of shapes and sizes and is not intended to be limited by the preferred embodiment. Numerous applications of the invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

We claim:

1. A hybrid communications node comprising:
a first interface exchanging first data with a first media in accordance with a first communication format;
a second interface exchanging second data with a second media in accordance with a second communication format; and,
a processor receiving the first data from said first interface in accordance with the first communication format, converting the received first data to the second communication format to provide a converted first data, and transmitting the converted first data to said second interface for reception by the second media.

2. The node of claim 1, wherein the first media comprises a cellular phone and the first communication format comprises a wireless signal, and the second media comprises a monitor and the second communication format comprises an electronic message.

3. The node of claim 1, wherein the first communication format is incompatible with the second communication format.

4. The node of claim 1, wherein said first interface comprises a wireless interface and said second interface comprises a wired interface.

5. The hybrid communications node of claim 1, wherein said node provides multiple radio services over the same radio channel.

6. The hybrid communications node of claim 5, for use in the cellular industry.

7. The hybrid communications node of claim 1, wherein said first and second communication formats comprise one of Internet, audio, text, phone, radio, television, data, video, optical, and satellite.

8. A communications station comprising: an antenna tower, an antenna affixed to the tower, a distribution/switching/transmission (DST) unit affixed to the tower and located adjacent to said antenna, a base unit located nearby said antenna tower, and a cable connecting said base unit to said routing unit.

9. The communications station of claim 8, said DST unit having a wireless interface for communicating with said antenna.

10. The communications station of claim 9, wherein said wireless interface comprises a radio interface for communicating radio signals.

11. The communications station of claim 9, wherein said wireless interface comprises a television interface for communication television signals.

12. The communications station of claim 8, wherein said cable comprises an umbilical cable which carries power from the base unit to the DST unit.

13. A communications station comprising: an antenna and a portable communications node having a processor for transmitting data to a media over said antenna.

14. An integrated distributed communications network comprising: a plurality of communications nodes, each said communications node having an interface and a processor for communicating data to remotely located communications nodes via said interface.

15. The integrated distributed communications network of claim 14, wherein a central office is not needed.

16. The integrated distributed communications network of claim 14, wherein said communications nodes provide discrete switching, routing, and transmission.

17. The integrated distributed communications network of claim 14, wherein a telecommunications transmission backbone is not needed.

18. The integrated distributed communications network of claim 14, wherein the network is a partial-mesh.

19. The integrated distributed communications network of claim 14, wherein said processor for at least one of said plurality of communications nodes detects a fault and modifies operation of said communication node in response to detecting the fault.

20. A housing comprising:
a cover having a front plate and a divider plate substantially perpendicular to said front plate, said divider plate having electronic components attached thereto;
an outer shell having an opening for removably receiving said cover so that the front plate forms an enclosure with said outer shell and said divider plate separates the enclosure into a first enclosure portion and a second enclosure portion, whereby said first enclosure portion contains the electronic components and blocks electronic interference with the electronic components.

21. The housing of claim 20, further comprising a shielded attached to said divider plate and surrounding the electronic components to further block electronic interference with the electronic components.
